(19) United States
(12) Patent Application Publication
(10) Pub. No.: US 2017/0123593 A1
(43) Pub. Date: May 4, 2017

(54) DETECTOR FOR DETERMINING A POSITION OF AT LEAST ONE OBJECT

(71) Applicant: BASF SE, Ludwigshafen (DE)

(72) Inventors: Robert SEND, Karlsruhe (DE); Ingmar BRUDER, Neuleiningen (DE); Stephan IRLE, Siegen (DE); Erwin THIEL, Siegen (DE)

(21) Appl. No.: 15/319,156

(22) PCT Filed: Jun. 16, 2015
(86) PCT No.: PCT/IB2015/054536

§ 371 Date: Dec. 15, 2016

(30) Foreign Application Priority Data
Jun. 16, 2014 (EP) 14172520.0

(51) Int. Cl. G06F 3/042; G01D 5/34; G06F 3/041; G01N 21/47

(52) U.S. Cl. CPC G06F 3/0421; G01N 21/4795; G01D 5/342; G06F 3/0416; G06F 2203/04101

(57) ABSTRACT

A detector (110) for determining a position of at least one object (112) with regard to at least one optical sensor (120) is proposed, wherein the optical sensor (120) has an image plane (122). The detector (110) comprises: at least one illumination source (134), wherein the illumination source (134) emits at least one light beam (136), wherein the light beam (136) comprises a component which is parallel to the image plane (122) of the optical sensor (120); the optical sensor (120), wherein the optical sensor (120) has a sensor region (126) in the image plane (122), wherein the optical sensor (120) is adapted to determine a transversal component of the position of the object (112) in an event where the object (112) approaches the optical sensor (120) in a manner that light is scattered from the component of the light beam (136) conducted parallel to the image plane (122) of the optical sensor (120), the transversal component of the position being a position in the image plane (122) of the optical sensor (120), the optical sensor (120) being adapted to generate at least one transversal sensor signal from the light scattered from the component of the light beam (136) conducted parallel to the image plane (122) of the optical sensor (120) in the sensor region (126), wherein the optical sensor (120) is further designed to generate at least one longitudinal sensor signal in a manner dependent on an illumination of the sensor region (126) by light which is scattered from the component of the light beam (136) conducted parallel to the image plane (122) of the optical sensor (120), wherein the longitudinal sensor signal is dependent on a variation of an intensity of the light is scattered from the component of the light beam (136) conducted parallel to the image plane (122) of the optical sensor (120) in the sensor region (126); and an evaluation device (132), wherein the evaluation device (132) is designed to generate at least one item of information on a transversal component of a position of the object (112) by evaluating the transversal sensor signal and wherein the evaluation device (132) is further designed to generate at least one item of information on a longitudinal component of a position of the object (112) by evaluating the longitudinal sensor signal.

### FIELD OF THE INVENTION

The invention relates to a detector for determining a position of at least one object. Furthermore, the invention relates to a human-machine interface and an entertainment device. Furthermore, the invention relates to a method for optically detecting a position of at least one object and to various uses of the detector. Such devices, methods and uses may preferably be employed, in particular as proximity sensors, for example in various areas of daily life, gaming, security technology, medical technology, or in the sciences. However, other applications are also possible.

### PRIOR ART

Human-machine interfaces which are controllable by touching a touch-sensitive (tactile) surface using an object related to a person, such as a finger of the person, have been known for a number of years. For this purpose, the tactile surface may be aligned with a display, thereby enabling a unidirectional and/or a bidirectional interaction between the person and a machine related with the human-machine interface. Currently, a kind of human-machine interfaces which are generally denoted as “touch screens” or “touch pads” are used in many areas, in particular for controlling phones, such as cellular phones, medical and/or or industrial equipment, or vendor machines, such as ticket or beverage machines, or for guiding purposes in a presentation of information, such as in administrative buildings, museums or for public transport.

However, tactile surfaces require to be touched by an object, such as by the finger of the person, which may be configured for providing enough capacitance in order to be able to induce a respective signal within the corresponding surface. Consequently, information with regard to a distance of the object may basically neither be recorded nor transmitted by use of the touch-sensitive surface. In addition, touching of a respective display which may be provided for use by more than one person, may, generally, not be considered as hygienic. Furthermore, the touching may also be difficult under circumstances where an item in connection with the hand of the person, such as gloves, may be required, e.g. in clean rooms, refrigerator rooms, or outdoor, and/or where dirty fingers are likely, such as in harsh working environments.

Therefore, proximity sensors which are operated in combination with a display have also been presented. As used herein, a proximity sensor may be adapted for detecting a position of at least one object, such as a finger, a hand, or another object related thereto, such as a pen, a pencil, a stylus, or a glove, which may pass the detector in a distance, in particular a close distance, therefrom, thus enabling a person to interact with the human-machine interface equipped with and/or connected to the display without being compelled to actually touch it.

US 2008/0297487 A1 describes a proximity sensor comprising at least one infrared emitter and at least one infrared receiver, which are located in the vicinity of the sensor, wherein the emitter permanently emits radiation as long as the sensor may be in operation. As soon as an object closely passes with respect to the sensor, a part of the emitted radiation may be reflected towards the receiver, thus, enabling the sensor to deduce information about the presence of an object close to the surface.

US 2013/0076695 A1 discloses a human-machine interfaces comprising a proximity sensor, wherein an interactive surface is provided. Herein, the interactive surface comprises a display area, at least one photosensitive sensor, and, optionally, a control unit connected to the display area and the sensor, wherein the display area, the sensor, and the control unit are formed by a deposition of organic conductive and semiconductive materials in liquid form on a dielectric substrate. Furthermore, the sensor comprises a photodiode, a photoresistor, or an array of photon sensors, wherein the array is capable of detecting variations of a shadow of an object and deducing information therefrom, such as a variation of the position of the object in front of the human-machine interface, e.g. the variation of a distance between the object and the interactive surface. In a particular embodiment, an array of back-lighting or light-emitting pixels, such as light-emitting diodes (LEDs), are arranged, in addition, in a plane parallel to the photon sensor array and between the photon sensor array and a transparent or a translucent protective coating, such as a glass plate or a plastic coating. In a further embodiment, the human-machine interface, additionally, comprises an array of infrared emitters which, in operation, permanently emit an infrared radiation, wherein, as soon as an object closely passes with respect to the sensor, a part of the emitted radiation may be reflected towards a neighboring photosensitive sensor within the array in order to deduce information about the presence of an object close to the surface. Furthermore, infrared emission with a frequency modulation may be provided, thus, enabling, on reception by the sensor, to discriminate shadow within the visible spectral range as described above from infrared. As a result, it may, thus, be possible to simultaneously use infrared operation and cast shadow detection in order to obtain additional information with respect to the position of the object.

Furthermore, a large number of optical sensors and photovoltaic devices are known from the prior art. While photovoltaic devices are generally used to convert electromagnetic radiation, for example, ultraviolet, visible or infrared light, into electrical signals or electrical energy, optical detectors are generally used for picking up image information and/or for detecting at least one optical parameter, for example, a brightness.

A large number of optical sensors which can be based generally on the use of inorganic and/or organic sensor materials are known from the prior art. Examples of such sensors are disclosed in US 2007/0176165 A1, U.S. Pat. No. 6,995,445 B2, DE 2501124 A1, DE 3225372 A1 or else in numerous other prior art documents. To an increasing extent, in particular for cost reasons and for reasons of large-area processing, sensors comprising at least one organic sensor material are being used, as described for example in US 2007/0176165 A1. In particular, so-called dye solar cells are increasingly of importance here, which are described generally, for example in WO 2009/013282 A1.

In WO 2012/110924 A1, on which the present invention is based and the content of which is herewith included by reference, a detector for optically detecting at least one object is proposed. The detector comprises at least one optical sensor, wherein the optical sensor has at least one sensor region. The optical sensor is designed to generate at least one sensor signal in a manner dependent on an illumination of the sensor region. The sensor signal, given the same total power of the illumination, is dependent on a geometry of the illumination, in particular on a beam cross section of the illumination on the sensor area. The detector furthermore has at least one evaluation device. The evaluation device is designed to generate at least one item of geometrical information from the sensor signal, in particular at least one item of geometrical information about the illumination and/or the object.

WO 2014/097181 A1 discloses a method and a detector for determining a position of at least one object by using at least one transversal optical sensor and at least one longitudinal optical sensor. Specifically, the use of sensor stacks is disclosed, in order to determine a longitudinal position of the object with a high degree of accuracy and without ambiguity.

Despite the advantages implied by the proximity sensors as presented above, there still is a need for a simple, cost-efficient, reliable, and improved proximity sensor, i.e. for a detector for determining a position of at least one object, particularly with respect to a display, which may preferably be used in a human-machine interface and/or an entertainment device. Thus, it may be desirable to provide a large-area proximity sensor, particularly in a combination with a display, which may be used to simultaneously detect a number of objects, preferentially at least two fingers.

### Problem Addressed by the Invention

Therefore, a problem addressed by the present invention is that of specifying devices and methods for determining a position of at least one object which at least substantially avoid the disadvantages of known devices and methods of this type. In particular, an improved proximity sensor for determining the position of an object in space and, preferably, for a reliable alignment with a display is desirable.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

As used herein, the expressions “have”, “comprise” and “contain” as well as grammatical variations thereof are used in a non-exclusive way. Thus, the expression “A has B” as well as the expression “A comprises B” or “A contains B” may both refer to the fact that, besides B, A contains one or more further components and/or constituents, and to the case in which, besides B, no other components, constituents or elements are present in A.

In a first aspect of the present invention, a detector for determining a position of at least one object is disclosed.

The “object” generally may be an arbitrary object, chosen from a living object and a non-living object. Thus, as an example, the object may be or may comprise one or more body parts of a human being, such as one or more fingers or a part of a hand of a user or a person. Additionally or alternatively, the object may comprise one or more articles and/or one or more parts of an article, in particular as article closely related to one or more of the fingers or the a part of the hand of the user, such as a pen, a pencil, a stylus, a glove, or a part thereof.

As used herein, a “position” may generally refer to an arbitrary item of information on a location and/or orientation of the object in space. For this purpose, as an example, one or more coordinate systems may be used, and the position of the object may be determined by using one, two, three or more coordinates. As an example, one or more Cartesian coordinate systems and/or other types of coordinate systems may be used. In one example, the coordinate system may be a coordinate system of the detector in which the detector has a predetermined position and/or orientation. As will be outlined in further detail below, the detector may have an optical axis, which may constitute a main direction of view of the detector. The optical axis may form an axis of the coordinate system, such as a z-axis. Further, one or more additional axes may be provided, preferably perpendicular to the z-axis.

In particular with respect to the present invention, the detector comprises an optical sensor which exhibits an image plane. As further used herein, the “image plane” may generally describe a planar structure which may confine the optical sensor at a side where it may be illuminated by at least one impinging light beam. In particular, for a purpose of using the detector according to the present invention as a proximity sensor, the “proximity sensor” may refer to an optical sensor being adapted for detecting a position of the at least one object, such as a finger, a hand, or another object related thereto, such as a pen, a pencil, a stylus, a glove, or a part thereof, which may pass the detector, particularly, in a close distance from the image plane. Consequently, the image plane may define a kind of a natural coordinate system with respect to the detector, wherein the image plane may be considered as the x-y plane and a perpendicular direction thereof be denoted the z direction. In this coordinate system, a direction parallel or antiparallel to the x-y plane may be regarded as comprising a transversal component and a coordinate along the z-axis may be considered a longitudinal coordinate. An arbitrary direction perpendicular to the longitudinal direction may, thus, be considered comprising a transversal component and an x- and/or y-coordinate may be considered a transversal coordinate.

However, other types of coordinate systems may be used alternatively. Thus, as an example, a cylindrical coordinate system may be employed, wherein the image plane may define an x-y plane with a center, from which a radial distance and an angular position may be given. In addition, a perpendicular direction with respect to the x-y plane may be denoted as the z direction. Still in this coordinate system, a direction parallel or antiparallel to the x-y plane may be regarded as comprising a transversal component and a coordinate along the z-axis may be considered a longitudinal coordinate.

In addition, the detector according to the present invention may further determine a motion of the at least one object. As used herein, the term “motion” may generally refer to an arbitrary item of information on a variation of the location and/or the orientation of the same object in space over a period of time. For this purpose, at least two items of information on the location and/or the orientation of the same object in space may particularly be combined in a manner to determine an extent of the variation of the position, which may be expressed in terms of a suitable parameter, such as a direction, a velocity, or an angular velocity. Whereas the direction determines only the course of the route which the object may pursue, the velocity further determines the rate at which the course is followed. In addition, while the object may not alter its position in its entirety during a specific period of time, it may still perform an internal movement, such as a rotation, wherein the rate of the rotation may be determined by the angular velocity.

According to the present invention, the detector comprises:
at least one illumination source, wherein the illumination source emits at least one light beam, wherein the light beam comprises a component which is parallel to an image plane of at least one optical sensor;
the optical sensor, wherein the optical sensor has a sensor region in the image plane, wherein the optical sensor is adapted to determine a transversal component of the position of the object in an event where the object approaches the optical sensor in a manner that light is scattered from the component of the light beam conducted parallel to the image plane of the optical sensor, the transversal component of the position being a position in the image plane of the optical sensor, the optical sensor being adapted to generate at least one transversal sensor signal from the light scattered from the component of the light beam conducted parallel to the image plane of the optical sensor in the sensor region, wherein the optical sensor is further designed to generate at least one longitudinal sensor signal in a manner dependent on an illumination of the sensor region by light which is scattered from the component of the light beam conducted parallel to the image plane of the optical sensor, wherein the longitudinal sensor signal is dependent on a variation of an intensity of the light is scattered from the component of the light beam conducted parallel to the image plane of the optical sensor in the sensor region; and
an evaluation device, wherein the evaluation device is designed to generate at least one item of information on a transversal component of a position of the object by evaluating the transversal sensor signal and wherein the evaluation device is further designed to generate at least one item of information on a longitudinal component of a position of the object by evaluating the longitudinal sensor signal.

As will be outlined in further detail below, the components of the detector listed above and/or below may be separate components. Alternatively, two or more of the components may be integrated into a common component. As an example, the illumination source may be formed as a separate illumination source independent from the optical sensor but may be connected to the optical sensor in order to illuminate the optical sensor. Alternatively, the illumination source may fully or partially be integrated into the optical sensor. In a similar manner, the evaluation device may be formed as a separate evaluation device independent from the optical sensor but may be connected to the optical sensor in order to receive the transversal sensor signal and the longitudinal sensor signal. Alternatively, the evaluation device may fully or partially be integrated into the optical sensor. A similar consideration is applicable to further optional components which might be added or appended to the detector according to the present invention.

As used herein, the at least one “transversal sensor signal” may generally be an arbitrary signal indicative of the transversal position. As an example, the transversal sensor signal may be or may comprise a digital and/or an analog signal. As an example, the transversal sensor signal may be or may comprise a voltage signal and/or a current signal. Additionally or alternatively, the transversal sensor signal may be or may comprise digital data. The transversal sensor signal may comprise a single signal value and/or a series of signal values. The transversal sensor signal may further comprise an arbitrary signal which is derived by combining two or more individual signals, such as by averaging two or more signals and/or by forming a quotient of two or more signals, as will be outlined in further detail below.

As used herein, the “optical sensor” generally is a device which is designed to generate at least one longitudinal sensor signal in a manner dependent on an illumination of the sensor region by the light beam, wherein the longitudinal sensor signal, given the same total power of the illumination, is dependent on a beam cross-section of the light beam in the sensor region. For potential embodiments of the optical sensor, reference may be made to WO 2012/110924 A1.

As will further be outlined below, preferably, the optical sensor may comprise one or more photo detectors, preferably one or more organic photodetectors and, most preferably, one or more dye-sensitized organic solar cells (DSCs, also referred to as dye solar cells), such as one or more solid dye-sensitized organic solar cells (s-DSCs). Thus, preferably, the detector may comprise one or more DSCs (such as one or more sDSCs) acting as the optical sensor. However, other kinds of materials and devices which may exhibit a “FiP” effect as explained below in more detail, may also be employed as the optical sensor.

As used herein, the term “evaluation device” may generally refer to an arbitrary device being designed to generate the at least one item of information on the position of the object. As an example, the evaluation device may be or may comprise one or more integrated circuits, such as one or more application-specific integrated circuits (ASICs), and/or one or more data processing devices, such as one or more computers, preferably one or more microcomputers and/or microcontrollers. Additional components may be comprised, such as one or more preprocessing devices and/or data acquisition devices, such as one or more devices for receiving and/or preprocessing of the transversal sensor signal and/or the longitudinal sensor signal, such as one or more AD-converters and/or one or more filters. Further, the evaluation device may comprise one or more data storage devices. Further, as outlined above, the evaluation device may comprise one or more interfaces, such as one or more wireless interfaces and/or one or more wire-bound interfaces.

The evaluation device may be adapted to perform at least one computer program, such as at least one computer program performing or supporting the step of generating the at least one item of information on the transversal component of the position of the at least one object and/or the step of generating the at least one item of information on the longitudinal component of the position of the at least one object. As an example, one or more algorithms may be implemented which, by using the transversal sensor signal and/or the longitudinal sensor signal as input variables, may perform a predetermined transformation into the transversal component and/or the longitudinal component of the position of the object.

As outlined above, preferably, the optical sensor is a photo detector having at least one first electrode, at least one second electrode and at least one photovoltaic material, wherein the photovoltaic material is embedded in between the first electrode and the second electrode. As used herein, a photovoltaic material generally is a material or combination of materials adapted to generate electric charges in response to an illumination of the photovoltaic material with light.

As used herein, the term “light” generally refers to electromagnetic radiation in one or more of the visible spectral range, the ultraviolet spectral range and the infrared spectral range. Therein, the term visible spectral range generally refers to a spectral range of 380 nm to 780 nm. The term infrared (IR) spectral range generally refers to electromagnetic radiation in the range of 780 nm to 1000 μm, preferably in the range of 780 nm to 3.0 μm. The term ultraviolet spectral range generally refers to electromagnetic radiation in the range of 1 nm to 380 nm, preferably in the range of 100 nm to 380 nm. Preferably, light as used within the present invention is visible light, i.e. light in the visible spectral range.

The term “light beam” may generally refer to an amount of light emitted into a specific direction. Thus, the light beam may be a bundle of the light rays having a predetermined extension in a direction perpendicular to a direction of propagation of the light beam. Preferably, the light beam may be or may comprise one or more Gaussian light beams which may be characterized by one or more Gaussian beam parameters, such as one or more of a beam waist, a Rayleigh-length or any other beam parameter or combination of beam parameters suited to characterize a development of a beam diameter and/or a beam propagation in space.

Preferably, the second electrode of the optical sensor may be a split electrode having at least two partial electrodes, wherein the optical sensor has a sensor area, wherein the transversal sensor signal indicates a position of the light beam in the sensor area. Thus, as outlined above, the optical sensor may be or may comprise one or more photo detectors, preferably one or more organic photo detectors, more preferably one or more DSCs or sDSCs. The sensor area may be a surface of the photo detector facing towards the object. The sensor area preferably may be oriented perpendicular to the optical axis. Thus, the transversal sensor signal may indicate a position of a light spot generated by the light beam in a plane of the sensor area of the optical sensor.

Generally, as used herein, the term “partial electrode” may refer to an electrode out of a plurality of electrodes, adapted for measuring at least one current and/or voltage signal, preferably independent from other partial electrodes. Thus, in case a plurality of partial electrodes is provided, the second electrode is adapted to provide a plurality of electric potentials and/or electric currents and/or voltages via the at least two partial electrodes, which may be measured and/or used independently.

When using at least one optical sensor having at least one split electrode having two or more partial electrodes as a second electrode, currents through the partial electrodes may be dependent on a position of the light beam in the sensor area. This may generally be due to the fact that Ohmic losses or resistive losses may occur on the way from a location of generation of electrical charges due to the impinging light to the partial electrodes. Thus, besides the partial electrodes, the second electrode may comprise one or more additional electrode materials connected to the partial electrodes, wherein the one or more additional electrode materials provide an electrical resistance. Thus, due to the Ohmic losses on the way from the location of generation of the electric charges to the partial electrodes through with the one or more additional electrode materials, the currents through the partial electrodes depend on the location of the generation of the electric charges and, thus, to the position of the light beam in the sensor area. For details of this principle of determining the position of the light beam in the sensor area, reference may be made to the preferred embodiments below and/or to the physical principles and device options as disclosed e.g. in U.S. Pat. No. 6,995,445 and/or US 2007/0176165 A1.

The optical sensor may further be adapted to generate the transversal sensor signal in accordance with the electrical currents through the partial electrodes. Thus, a ratio of electric currents through two horizontal partial electrodes may be formed, thereby generating an x-coordinate, and/or a ratio of electric currents through to vertical partial electrodes may be formed, thereby generating a y-coordinate. The detector, preferably the optical sensor and/or the evaluation device, may be adapted to derive the information on the transversal position of the object from at least one ratio of the currents through the partial electrodes. Other ways of generating position coordinates by comparing currents through the partial electrodes are feasible.

The partial electrodes generally may be defined in various ways, in order to determine a position of the light beam in the sensor area. Thus, two or more horizontal partial electrodes may preferably be provided in order to determine a horizontal coordinate or x-coordinate, and two or more vertical partial electrodes may preferably be provided in order to determine a vertical coordinate or y-coordinate. Thus, the partial electrodes may be provided at a rim of the sensor area, wherein an interior space of the sensor area remains free and may be covered by one or more additional electrode materials. As will be described below in more detail, in order to be able to adapt the size of the detector to the area of the display in front of which the detector may be located, it may be preferable to provide two, three, four, or even more horizontal partial electrodes and/or vertical partial electrodes. As will be outlined in further detail below, the additional electrode material preferably may be a transparent additional electrode material, such as a transparent metal and/or a transparent conductive oxide and/or, most preferably, a transparent conductive polymer.

Further preferred embodiments may refer to the photovoltaic material. Thus, the photovoltaic material of the optical sensor may comprise at least one organic photovoltaic material. Thus, generally, the optical sensor may be an organic photo detector. Preferably, the organic photo detector may be a dye-sensitized solar cell. The dye-sensitized solar cell preferably may be a solid dye-sensitized solar cell, comprising a layer setup embedded in between the first electrode and the second electrode, the layer setup comprising at least one n-semiconducting metal oxide, at least one dye, and at least one solid p-semiconducting organic material. Further details and optional embodiments of the dye-sensitized solar cell (DSC) will be disclosed below.

The at least one first electrode of the optical sensor preferably is transparent. As used in the present invention, the term transparent generally refers to the fact that the intensity of light after transmission through the transparent object equals to or exceeds 10%, preferably 40% and, more preferably, 60% of the intensity of light before transmission through the transparent object. More preferably, the at least one first electrode of the optical sensor may fully or partially be made of at least one transparent conductive oxide (TCO). As an example, indium-doped tin oxide (ITO) and/or fluorine-doped tin oxide (FTO) may be named. Further examples will be given below.

Further, the at least one second electrode of the optical sensor preferably may fully or partially be transparent. Thus, specifically, the at least one second electrode may comprise two or more partial electrodes and at least one additional electrode material contacting the two or more partial electrodes. The two or more partial electrodes may be intransparent. As an example, the two or more partial electrodes may fully or partially be made of a metal. Thus, the two or more partial electrodes preferably are located at a rim of the sensor area. The two or more partial electrodes, however, may electrically be connected by the at least one additional electrode material which, preferably, is transparent. Thus, the second electrode may comprise an intransparent rim having the two or more partial electrodes and a transparent inner area having the at least one transparent additional electrode material. More preferably, the at least one second electrode of the optical sensor, such as the above-mentioned at least one additional electrode material, may fully or partially be made of at least one conductive polymer, preferably a transparent conductive polymer. As an example, conductive polymers having an electrical conductivity of at least 0.01 S/cm may be used, preferably of at least 0.1 S/cm or, more preferably, of at least 1 S/cm or even at least 10 S/cm or at least 100 S/cm. As an example, the at least one conductive polymer may be selected from the group consisting of: a poly-3,4-ethylenedioxythiophene (PEDOT), preferably PEDOT being electrically doped with at least one counter ion, more preferably PEDOT doped with sodium polystyrene sulfonate (PEDOT:PSS); a polyaniline (PANI); a polythiophene.

As outlined above, the conductive polymer may provide an electrical connection between the at least two partial electrodes. The conductive polymer may provide an Ohmic resistivity, allowing for determining the position of charge generation. Preferably, the conductive polymer provides an electric resistivity of 0.1-20 kΩ between the partial electrodes, preferably an electric resistivity of 0.5-5.0 kΩ and, more preferably, an electric resistivity of 1.0-3.0 kΩ.

Generally, as used herein, a conductive material may be a material which have a specific electrical resistance of less than 10⁴, less than 10³, less than 10², or of less than 10 Ωm. Preferably, the conductive material has a specific electrical resistance of less than 10⁻¹, less than 10⁻², less than 10⁻³, less than 10⁻⁵, or less than 10⁻⁶ Ωm. Most preferably, the specific electrical resistance of the conductive material is less than 5×10⁻⁷ Ωm or is less than 1×10⁻⁷ Ωm, particularly in the range of the specific electrical resistance of aluminum.

In a particularly preferred embodiment, the optical sensor is transparent. This feature may particularly allow locating the detector according to the present invention in front of a display, thereby reducing the transmission of a light beam as emitted by the display to a rather small extent, thus, allowing a user looking at the display with as little interference as possible. Consequently, each of the components of the detector which are located in a manner that they may be impinged by the light beam as emitted by the display most preferably comprises a transparent material. Herein, the substrate employed for the optical sensor may be rigid or else flexible. Suitable substrates are, in particular, plastic sheets or films and, especially, glass sheets or glass films. Shape-changing materials, such as shape-changing polymers, constitute an example of materials which may preferentially be employed as flexible substrates. Furthermore, the substrate may be covered or coated, in particular, for the purpose of reducing and/or modifying reflections of the incident light beam.

In addition, only a single optical sensor may be used in order to further reduce any possible interference. However, in a specific embodiment, two optical sensors may be present, such as a separate transversal optical sensor and a separate longitudinal optical sensor, such as independent photo detectors and, more preferably, independent DSCs or sDSCs, wherein the two optical sensors may be arranged in a manner that the sensor regions of both optical sensors may be oriented in parallel with respect to each other.

Further embodiments of the present invention refer to the illumination source. As will be outlined in further detail below, one or more illumination sources are provided which illuminate the object, such as by using one or more rays or beams, such as one or more rays or beams having a predetermined characteristic. Herein, the light beam further propagating from the object to the detector might be a light beam, wherein, in an event where the object approaches the optical sensor, the light beam may be scattered elastically or inelastically from the component of the light beam conducted parallel to the image plane of the optical sensor, thereby generating the light beam which propagates to the detector. As used herein, the light beam may preferably be conducted parallel to the image plane of the optical sensor. However, the present invention may also be applicable in a situation in which the light beam may not be conducted strictly parallel to the image plane of the optical sensor but in a manner that the light beam may not touch the image plane of the optical sensor and, at the same time, may still comprise a finite component being conducted parallel to the image plane of the optical sensor, in particular for being scattered elastically or inelastically by an object, such as the finger or the hand of the user or the other object related thereto.

As outlined above, the longitudinal sensor signal, given the same total power of the illumination by the light beam, is dependent on a beam cross-section of the light beam in the sensor region of the optical sensor. As used herein, the term beam cross-section generally refers to a lateral extension of the light beam or a light spot generated by the light beam at a specific location. In case a circular light spot is generated, a radius, a diameter or a Gaussian beam waist or twice the Gaussian beam waist may function as a measure of the beam cross-section. In case non-circular light-spots are generated, the cross-section may be determined in any other feasible way, such as by determining the cross-section of a circle having the same area as the non-circular light spot, which is also referred to as the equivalent beam cross-section.

Thus, given the same total power of the illumination of the sensor region by the light beam, a light beam having a first beam diameter or beam cross-section may generate a first longitudinal sensor signal, whereas a light beam having a second beam diameter or beam-cross section being different from the first beam diameter or beam cross-section generates a second longitudinal sensor signal being different from the first longitudinal sensor signal. Thus, by comparing the longitudinal sensor signals, at least one item of information on the beam cross-section, specifically on the beam diameter, may be generated. For details of this effect, reference may be made to WO 2012/110924 A1. Specifically in case one or more beam properties of the light beam propagating from the object to the detector are known, the at least one item of information on the longitudinal position of the object may thus be derived from a known relationship between the longitudinal sensor signal and a longitudinal position of the object. The known relationship may be stored in the evaluation device as an algorithm and/or as one or more calibration curves. As an example, specifically for Gaussian beams, a relationship between a beam diameter or beam waist and a position of the object may easily be derived by using the Gaussian relationship between the beam waist and a longitudinal coordinate.

The above-mentioned effect, which is also referred to as the “FiP-effect” (alluding to the effect that the beam cross section φ influences the electric power P generated by the optical sensor) may depend on or may be emphasized by an appropriate modulation of the light beam, as disclosed in WO 2012/110924 A1. Thus, preferably, the illumination source may furthermore have at least one modulation device for modulating the illumination. The detector may be designed to detect at least two longitudinal sensor signals in the case of different modulations, in particular at least two sensor signals at respectively different modulation frequencies. In this case, the evaluation device may be designed to generate the at least one item of information on the longitudinal position of the object by evaluating the at least two longitudinal sensor signals.

Generally, the optical sensor may be designed in such a way that the longitudinal sensor signal, given the same total power of the illumination, is dependent on a modulation frequency of a modulation of the illumination. Further details and exemplary embodiments will be given below. This property of frequency dependency is specifically provided in DSCs and, more preferably, in sDSCs. However, other types of optical sensors, preferably photo detectors and, more preferably, organic photo detectors may exhibit this effect.

Preferably, the optical sensor is a thin film device, having a layer setup of layer including electrode and photovoltaic material, the layer setup having a thickness of preferably no more than 1 mm, more preferably of at most 500 μm or even less. Thus, the sensor region of the optical sensor preferably may be or may comprise an area, which may be formed by a surface of the respective device, wherein the surface may face towards the object or may face away from the object. Hereby, it may further be feasible to arrange the optical sensor in a manner that a surface comprising the sensor region may face towards the object where an opposite surface may face toward the display. Such a kind of arrangement of the respective devices might be helpful to reduce reflections within the light path.

Preferably, the sensor region of the optical sensor may be formed by a continuous sensor region, such as one continuous sensor area or sensor surface per device. Thus, preferably, the sensor region of the optical sensor may be formed by exactly one continuous sensor region.

The sensor signal preferably is a uniform sensor signal for the entire sensor region of the optical sensor.

The optical sensor may have a sensor region providing a sensitive area, also referred to as a sensor area, which may particularly be adapted to the display for which it may be employed as proximity sensor. For this purpose, a sensor area of at least 10 cm², preferably of at least 25 cm², such as a sensor area of 25 cm² to 10 m², preferably a sensor area of 50 cm² to 1 m², may be preferred. The sensor area preferably has a rectangular geometry, such as a 16:9 or a 4:3 geometry, particularly adapted to the display for which it may be employed as proximity sensor. However, other geometries and/or sensor areas are feasible.

The longitudinal sensor signal preferably may be selected from the group consisting of a current (such as a photocurrent) and a voltage (such as a photo voltage). Similarly, the transversal sensor signal preferably may be selected from the group consisting of a current (such as a photocurrent) and a voltage (such as a photo voltage) or any signal derived thereof, such as a quotient of currents and/or voltages. Further, the longitudinal sensor signal and/or the transversal sensor signal may be preprocessed, in order to derive refined sensor signals from raw sensor signals, such as by averaging and/or filtering.

Further preferred embodiments refer to the evaluation device. Thus, the evaluation device may be designed to generate the at least one item of information on the longitudinal component of the position of the object from at least one predefined relationship between the geometry of the illumination and a relative positioning of the object with respect to the detector, preferably taking account of a known power of the illumination and optionally taking account of a modulation frequency with which the illumination is modulated.

As outlined above, the object is illuminated by using at least one illumination source generating light, wherein, in an event where the object approaches the optical sensor, the light is scattered elastically or inelastically from the component of the light beam conducted parallel to the image plane of the optical sensor, thereby generating the light beam which propagates to the detector. The illumination source itself may be part of the detector. Thus, the detector may comprise at least one illumination source, preferably more than one illumination source, preferably a multitude of illumination sources. The illumination source generally may be selected from: an illumination source, which is at least partly connected to the object and/or is at least partly identical to the object; an illumination source which is designed to at least partly illuminate the object with a radiation, preferably light, wherein the light beam preferably is generated by elastic or inelastic scattering of the component of the light beam conducted parallel to the image plane of the optical sensor. For this purpose, the light beam might be shaped appropriately, such as by using an illumination source generating a light beam having known propagation properties, such as a known Gaussian profile. For this purpose, the illumination source itself may generate the light beam having the known properties, which, for example, is the case for many types of lasers, as the skilled person knows. Additionally or alternatively, the illumination source and/or the detector may have one or more beam-shaping elements, such as one or more lenses and/or one or more diaphragms, in order to provide a light beam having known properties, as the skilled person will recognize. Additionally or alternatively, the illumination source and/or the detector may have one or more wavelength-selective elements, such as one or more filters, such as one or more filter elements for filtering out wavelengths outside an excitation maximum of the optical sensor.

Generally, as outlined above, the evaluation device may be adapted to generate the at least one item of information on the longitudinal position of the object by determining a diameter of the light beam from the longitudinal sensor signal. As used herein and as used in the following, the diameter of the light beam or, equivalently, a beam waist of the light beam might be used to characterize the beam cross-section of the light beam at a specific location. As outlined above, a known relationship might be used between the longitudinal position of the object and the beam cross-section in order to determine the longitudinal position of the object by evaluating the longitudinal sensor signal. As an example, as outlined above, a Gaussian relationship might be used, assuming that the light beam propagates at least approximately in a Gaussian Manner.

Thus, generally, the evaluation device may be adapted to compare the beam cross-section and/or the diameter of the light beam with known beam properties of the light beam in order to determine the at least one item of information on the longitudinal position of the object, preferably from a known dependency of a beam diameter of the light beam on at least one propagation coordinate in a direction of propagation of the light beam and/or from a known Gaussian profile of the light beam.

In a preferred embodiment, the evaluation device may be designed to generate a specific command based on the at least one item of information as described above and/or below, wherein the item of information may relate to a position of the object. As further used herein, the term “command” may refer to an arbitrary sequence of at least one item of information being configured to be interpreted as an instruction by a computer program to be executed on a computer. For this purpose, the evaluation device may further be designed to transfer the specific command to the computer in order to effect an instruction by the computer through using the corresponding computer program.

More specifically, the specific command may comprise at the least two different items of information which may be interpreted as a gesture. As generally used in computing, the term “gesture” is considered as a combination of a first instruction provided by a movement of a classical pointing device, such as of a mouse, with a second instruction provided by the classical pointing device, i.e. the mouse, without being required to move the pointing device, wherein the second instruction may, for example, be a click or a double-click. Consequently, the combination of the first instruction with the second instruction which may be denoted as “gesture” may, thus, be recognized as the specific command by the computer program. Thus, the gesture may provide a quick access to at least one function of the computer program. In particular with regard to a non-classical pointing device, such as at least one finger of a user or, alternatively or in addition, an object, such as a pen, as used by the at least one finger of the user, wherein the non-classical pointing device may, particularly, be employed in order to operate a touch-screen or a proximity sensor in front of a display, the term “gesture” may more generally relate to an interpretation of at least two different items of information by the evaluation device. As an example, the gesture may comprise using two fingers, wherein a first finger performs a downwards motion and a second finger performs an upwards motion, in order to provide a function, usually denoted as a “zoom function”, for enlarging a section of an image currently displayed on a screen. Alternatively, the two fingers may provide a further function, usually denoted as a “rotation”, for rotating an item as currently displayed on the screen. In these particular examples, at least four different items of information relating to at least two positions of the two separate fingers are required in order to provide sufficient items of information to the specific command which may then be transferred by the evaluation device to the computer in order to be performed as the instruction provided by the user, i.e. enlarging the respective section of the image currently displayed on the screen.

In particular, the gesture may comprise a function selected from a click, a double click, a rotation, a zoom function and a drag-and-drop movement. However, other kinds of gestures are possible. As used herein, the “click” function may refer to a gesture where the user may select a predefined section, such as an underlined text passage or an emphasized area, also denoted as a “button”, from the image as currently displayed on the screen. Whereas the click or single click gesture may usually be employed for confirming a selection of the user, such as by further highlighting the emphasized area in order to provide a respective information to the user, the “double click” gesture, which may generally comprise two separate consecutive single clicks within a predefined period of time, may generally be employed for actually performing an instruction according to a respective choice of the use. However, it may still be possible to actually perform the respective choice of the user by already interpreting the single click gesture in the same manner as described here for the double click gesture. As further used herein, the “drag and drop” function may comprise a gesture in which the user may select a virtual object as displayed on the screen by selecting it and, in addition, by moving it to a different location on the screen, such as on another virtual object as further displayed on the same screen. Thus, the drag and drop gesture may, in particular, be employed in order to generate a kind of action or a type of association between two virtual objects as the instruction to be provided by the evaluation unit.

Within this regard, the detector according to the present invention may, particularly, be suited to interpret a large number of different gestures, such as those mentioned but also others which are not described here in further detail. The reason for this distinction is provided by the capability of the detector to be able to provide concurrently at least one item of information on a transversal component of a position of the object, in particular by evaluating the transversal sensor signal, and to provide at least one further item of information on a longitudinal component of the position of the same object, in particular by evaluating the longitudinal sensor signal. Thus, for the evaluation device both the transversal component and the longitudinal component of the at least one non-classical pointing device, i.e. the at least one finger of the user or an object conducted by the at least one finger of the user, are concurrently available for creating a specific command which may, in particular, comprise a gesture and which may be used for generating an instruction to a computer program as being executed on a computer which may be in relationship with a display, wherein the detector according to the present invention may be placed in front of the display. Consequently, the detector may be used in relationship with the display as a proximity sensor, wherein, however, the proximity sensor may not only be able to recognize a single item of information related to a single position of a single finger, thus providing only information about a presence of the finger within the image plane, but may also be capable of recording at least two different items of information related to separate positions of at least one finger, wherein the two separate positions may also differ with respect to the distance perpendicular to the image plane, thus providing sufficient information to be employed for a gesture recognition above the image plane without a requirement for any further classical or non-classical pointing device. In other words, the detector according to the present invention provides a basis for a full gesture recognition, wherein the gesture may be performed entirely in a volume above the image plane in a manner that no necessity might remain for touching any physical object, such as a display or a pointing device.

In further preferred embodiment, the detector according to the present invention may comprise more than one separate illumination source, wherein the separate illumination sources may form a frame which may fully or at least partially enclose the image plane and/or the optical sensor, such as in a rectangular or an annular fashion in which they surround or encompass the optical sensor. However, other arrangements are possible.

In a particular preferred embodiment, the illumination source may comprise at least one laser and/or at least one incandescent lamp and/or at least one semiconductor light source, in particular, at least one light-emitting diode (LED), in particular an inorganic and/or an organic light-emitting diode (OLED). Owing to their simplicity and easy handling, the use of light-emitting diodes as illumination sources, is particularly preferred. The illumination source of the detector can generally be adapted to the optical properties of the object, for example in terms of its wavelength. Various embodiments are possible. Preferably, the at least one optional illumination source generally may emit light in at least one of: the ultraviolet (UV) spectral range, preferably in the range of 200 nm to 380 nm; the visible spectral range (380 nm to 780 nm); the infrared (IR) spectral range, preferably in the range of 780 nm to 15.0 μm. Most preferably, the illumination source is adapted to emit light in the infrared (IR) spectral range, preferably in the range of 780 nm to 3 μm, most preferably in the near-infrared (NIR) spectral range, such as at 780 nm to 1400 nm.

As described above, the detector according to the present invention may further comprise at least one modulation device for modulating the illumination of the at least one light beam as emitted by the at least one illumination source. In a particular embodiment, wherein at least two separate illumination sources may be present, the at least two separate illumination sources may, thus, differ by a frequency which may be employed for modulating the illumination of each illumination source. This embodiment may, thus, provide a specific modulation pattern above the image plane since the positions and the modulation frequencies of the different illumination sources are known. Consequently, it may, therefore, by this manner also be feasible to distinguish between different objects being located at different positions, such as at least two different fingers of a hand of a user, since each specific object may, at its respective location, experience a specific modulation pattern which it may influence by its respective presence. As a result, the detector according to the present invention may be able to detect and resolve positions and/or motions of at least two fingers of a hand above the image plane, such as complex gestures as performed by more than one or two fingers. Accordingly, the present invention may, thus, provide a human-machine interface which may initiate novel ways for exchanging both simple and complex items of information between a user and a machine.

In a further aspect of the present invention, a human-machine interface for exchanging at least one item of information between a user and a machine is proposed. The human-machine interface as proposed may make use of the fact that the above-mentioned detector in one or more of the embodiments mentioned above or as mentioned in further detail below may be used by one or more users for providing information and/or commands to a machine. Thus, preferably, the human-machine interface may be used for inputting control commands.

The human-machine interface comprises at least one detector according to the present invention, such as according to one or more of the embodiments disclosed above and/or according to one or more of the embodiments as disclosed in further detail below, wherein the human-machine interface is designed to generate at least one item of geometrical information of the user by means of the detector wherein the human-machine interface is designed to assign to the geometrical information at least one item of information, in particular at least one control command.

Generally, as used herein, the at least one item of geometrical information of the user may imply one or more items of information on a transversal position and/or on a longitudinal position of one or more body parts of the user and/or an item configured for a movement by the user. Thus, preferably, the geometrical information of the user may imply one or more items of information on a transversal component and/or a longitudinal component of the position as provided by the evaluation device of the detector. The body part of the user, a plurality of body parts of the user, or the article adapted for a movement by the user may be regarded as one or more objects which may be detected by the at least one detector.

In a particularly preferred embodiment, the human-machine interface may comprise at least one display, wherein the at least one optical sensor comprised in the detector is transparent and/or translucent and is located with respect to the display in a manner that the display is fully or partially visible through the optical sensor, particularly, in order to employ the optical sensor as proximity sensor as described above. As used herein, the “display” is an arbitrary device which comprises a usually flat panel being capable of visually presenting information which may generally change over time, in particular for visual reception by a user. According to the present invention, the display may particularly be a dynamic display, preferably a display selected from a cathode ray tube (CRT), a liquid crystal display (LCD), a plasma screen, a light-emitting diode (LED) screen, an organic light-emitting diode (OLED) screen, and a field emission display (FED). However, other kinds of display are feasible.

In a further aspect of the present invention, an entertainment device for carrying out at least one entertainment function is disclosed. As used herein, an entertainment device is a device which may serve the purpose of leisure and/or entertainment of one or more users, in the following also referred to as one or more players. As an example, the entertainment device may serve the purpose of gaming, preferably computer gaming. Additionally or alternatively, the entertainment device may also be used for other purposes, such as for exercising, sports, physical therapy or motion tracking in general. Thus, the entertainment device may be implemented into a computer, a computer network or a computer system or may comprise a computer, a computer network or a computer system which runs one or more gaming software programs.

The entertainment device comprises at least one human-machine interface according to the present invention, such as according to one or more of the embodiments disclosed above and/or according to one or more of the embodiments disclosed below. The entertainment device is designed to enable at least one item of information to be input by a player by means of the human-machine interface. The at least one item of information may be transmitted to and/or may be used by a controller and/or a computer of the entertainment device.

As described above, the at least one item of information preferably may comprise at least one command adapted for influencing the course of a game. Thus, as an example, the at least one item of information may include at least one item of information on at least one of a position, an orientation, and/or a movement of one or more body parts, such as the fingers, of the player, thereby allowing for the player to simulate a specific position and/or action required for gaming.

The entertainment device, preferably a controller and/or a computer of the entertainment device, is designed to vary the entertainment function in accordance with the information. Thus, as outlined above, a course of a game might be influenced in accordance with the at least one item of information. Thus, the entertainment device might include one or more controllers which might be separate from the evaluation device of the at least one detector and/or which might be fully or partially identical to the at least one evaluation device or which might even include the at least one evaluation device. Preferably, the at least one controller might include one or more data processing devices, such as one or more computers and/or microcontrollers.

In a further embodiment of the present invention, the entertainment device may be part of an equipment, the equipment being a mobile piece or, in particular, an immobile piece, wherein the equipment may at least partially incorporate the entertainment device. The equipment may include a single, separate piece being located at a position, either a fixed position or a position at least intermittently subject to a variation, but the equipment may also comprise at least two pieces, preferably two to ten pieces, such as three, four, five, or six pieces, wherein the at least two pieces may be distributed over at least two positions differing from each other within an area, such as a room or a part thereof. Hereby, the entertainment device may be part of the equipment, wherein preferably some or each piece of the equipment may exhibit a part of the entertainment device, e.g. in such a manner that some or each piece of the equipment may comprise at least one detector according to the present invention or a part thereof, such as a sensor. As used herein, “immobile equipment” may include an immobile electronic article, in particular, designated as consumer electronics, wherein “consumer electronics” comprises electronic articles equipped with a display preferentially intended for everyday use, mainly in entertainment, communications and office matters, such as radio receivers, monitors, television sets, audio players, video players, personal computers and/or telephones.

In a further embodiment of the present invention, the object which may constitute a target of the at least one detector comprised within the at least one human-machine interface of the entertainment device, may be part of a controller as comprised within mobile equipment, wherein the mobile equipment may be configured to control another mobile equipment or immobile equipment. As used herein, “mobile equipment” may, thus, include mobile electronic articles equipped with a display, in particular, designated as consumer electronics, such as mobile phones, radio receivers, video recorders, audio players, digital cameras, camcorders, mobile computers, video game consoles and/or other devices adapted for remote control. This embodiment may particularly allow controlling immobile equipment with any kind of mobile equipment, preferably with a lesser number of pieces of equipment. As a non-limiting example, it may, thus, be possible to simultaneously control for example both a game console and a television set by using a mobile phone.

Additionally or alternatively, the object which may constitute the target of the detector may further be equipped with an additional sensor (apart from the sensors as comprised within the detector) particularly configured for determining a physical and/or chemical quantity related to the object, such as an inertia sensor for measuring the inertial motion of the object, or an acceleration sensor for determining the acceleration of the object. However, besides these preferred examples, other kinds of sensors adapted for acquiring further parameter related to the object, such as a vibrational sensor for determining vibrations of the object, a temperature sensor for recording the temperature of the object, or a humidity sensor for recording the humidity of the object may be employed. An application of the additional sensor within the object may allow improving the quality and/or the scope of the detection of the position of the object. As a non-limiting example, the additional inertia sensor and/or acceleration sensor may particularly be configured to record additional movements of the object, such as a rotation of the object, which may particularly be employed for increasing the accuracy of the object detection. Moreover, the additional inertia sensor and/or acceleration sensor may preferentially still be addressed in a case where the object being equipped with at least one of these sensors may leave a visual range of the detector comprised within the human-machine interface of the entertainment device. In this case, it might, nevertheless, be possible to follow the object after the object may have left the visual range of the detector by still being able to recording signals emitted from at least one of these sensors and using these signals for determining the location of the object by taking into account its actual inertia and acceleration values and calculating the position therefrom.

In a further aspect of the present invention, a method for determining a position of at least one object is disclosed. The method preferably may make use of at least one detector according to the present invention, such as of at least one detector according to one or more of the embodiments disclosed above or disclosed in further detail below. Thus, for optional embodiments of the method, reference might be made to the embodiments of the detector.

The method comprises the following steps, which may be performed in the given order or in a different order. Further, additional method steps might be provided which are not listed. Further, two or more or even all of the method steps might be performed at least partially simultaneously. Further, two or more or even all of the method steps might be performed twice or even more than twice, repeatedly.

In a first method step, which might also be referred to as a step of illuminating the object, at least one illumination source is used. Herein the illumination source emits at least one light beam, wherein the light beam comprises a component which is parallel to the image plane of the optical sensor. As already described above, the light beam may preferably be emitted parallel to the image plane of the optical sensor. However, the present invention may also be applicable in a situation in which the light beam may not be emitted strictly parallel to the image plane of the optical sensor but in a manner that the light beam may not touch the image plane of the optical sensor and, at the same time, may still comprise a finite component being emitted parallel to the image plane of the optical sensor, in particular for being scattered elastically or inelastically by an object, such as the finger or the hand of the user or the other object related thereto.

In a further method step, which might also be referred to as a step of determining at least one position, at least one optical sensor is used. Accordingly, the optical sensor has a sensor region in the image plane, wherein the optical sensor is adapted to determine a transversal component of the position of the object in an event where the object approaches the optical sensor in a manner that light is scattered from the component of the light beam conducted parallel to the image plane of the optical sensor, the transversal component of the position being a position in the image plane of the optical sensor, the optical sensor being adapted to generate at least one transversal sensor signal from the light scattered from the component of the light beam conducted parallel to the image plane of the optical sensor in the sensor region, wherein the optical sensor is further designed to generate at least one longitudinal sensor signal in a manner dependent on an illumination of the sensor region by light which is scattered from the component of the light beam conducted parallel to the image plane of the optical sensor, wherein the longitudinal sensor signal is dependent on a variation of an intensity of the light is scattered from the component of the light beam conducted parallel to the image plane of the optical sensor in the sensor region.

In a further method step, which might also be referred to as an evaluation step, at least one evaluation device is used. Within this regard, the evaluation device is designed to generate at least one item of information on a transversal component of a position of the object by evaluating the transversal sensor signal and wherein the evaluation device is further designed to generate at least one item of information on a longitudinal component of a position of the object by evaluating the longitudinal sensor signal.

In a further aspect of the present invention, a use of a detector according to the present invention is disclosed. Therein, a use of the detector for a purpose of use is proposed, selected from the group consisting of: a position measurement, in particular as a proximity sensor; a distance measurement, in particular as a proximity sensor; a human-machine interface application; an entertainment application; a security application.

In the following, some additional remarks regarding potential embodiments of the detector, the human-machine interface, the entertainment system and the method according to the present invention are given. As outlined above, preferably, for potential details of the setups of the detector, reference may be made to WO 2012/110924 A1, specifically with regard to potential electrode materials, organic materials, inorganic materials, layer setups and further details.

Generally, it shall be noted that, in the context of the present invention, an optical sensor may refer to an arbitrary element which is designed to convert at least one optical signal into a different signal form, preferably into at least one electrical signal, for example a voltage signal and/or a current signal. In particular, the optical sensor can comprise at least one optical-electrical converter element, preferably at least one photodiode and/or at least one solar cell. As is explained in even greater detail below, in the context of the present invention, preference is attached particularly to a use of at least one organic optical sensor, that is to say an optical sensor which comprises at least one organic material, for example at least one organic semiconductor material.

In the context of the present invention, a sensor region should be understood to mean a two-dimensional region which preferably, but not necessarily, is continuous and can form a continuous region, wherein the sensor region is designed to vary at least one measurable property, in a manner dependent on the illumination. By way of example, said at least one property can comprise an electrical property, for example, by the sensor region being designed to generate, solely or in interaction with other elements of the optical sensor, a photo voltage and/or a photocurrent and/or some other type of signal. In particular, the sensor region can be embodied in such a way that it generates a uniform, preferably a single, signal in a manner dependent on the illumination of the sensor region. The sensor region can thus be the smallest unit of the optical sensor for which a uniform signal, for example, an electrical signal, is generated, which preferably can no longer be subdivided to partial signals, for example for partial regions of the sensor region. The optical sensor each can have one or else a plurality of such sensor regions, the latter case for example by a plurality of such sensor regions being arranged in a two-dimensional and/or three-dimensional matrix arrangement.

The at least one sensor region can comprise for example at least one sensor area, that is to say a sensor region whose lateral extent considerably exceeds the thickness of the sensor region, for example by at least a factor of 10, preferably by at least a factor of 100 and particularly preferably by at least a factor of 1000. Examples of such sensor areas can be found in organic or inorganic photovoltaic elements, for example, in accordance with the prior art described above, or else in accordance with the exemplary embodiments described in even greater detail below. The detector can have one or a plurality of such optical sensors and/or sensor regions. By way of example, a plurality of optical sensors can be arranged linearly in a spaced-apart manner or in a two-dimensional arrangement. Other embodiments are also possible.

The at least one optical sensor, as outlined above, can be designed for example in such a way that the longitudinal sensor signal, given the same power of the illumination, that is to say for example given the same integral over the intensity of the illumination on the sensor area, is dependent on the geometry of the illumination, that is to say for example on the diameter and/or the equivalent diameter for the sensor spot. By way of example, the longitudinal optical sensor can be designed in such a way that upon a doubling of the beam cross section given the same total power, a signal variation occurs by at least a factor of 3, preferably by at least a factor of 4, in particular a factor of 5 or even a factor of 10. This condition can hold true for example for a specific focusing range, for example for at least one specific beam cross section. Thus, by way of example, the longitudinal sensor signal can have, between at least one optimum focusing at which the signal can have for example at least one global or local maximum and a focusing outside said at least one optimum focusing, a signal difference by at least a factor of 3, preferably by at least a factor of 4, in particular a factor of 5 or even a factor of 10. In particular, the longitudinal sensor signal can have as a function of the geometry of the illumination, for example of the diameter or equivalent diameter of a light spot, at least one pronounced maximum, for example with a boost by at least a factor of 3, particularly preferably by at least a factor of 4 and particularly preferably by at least a factor of 10. Consequently, the optical sensor is based on the above-mentioned FiP-effect, which is disclosed in detail in WO 2012/110924 A1. Thus, specifically in sDSCs, the focusing of the light beam may play a decisive role, i.e. the cross-section or cross-sectional area on which a certain number of auf photons (nph) is incident. The more tightly the light beam is focused, i.e. the smaller its cross-section, the higher the photo current may be. The term ‘FiP’ expresses the relationship between the cross-section φ (Fi) of the incident beam and the solar cell's power (P).

Such effects of the dependence of the at least one longitudinal sensor signal on a beam geometry, preferably a beam cross-section of the at least one light beam, were observed in the context of the investigations leading to the present invention in particular in the case of organic photovoltaic components, that is to say photovoltaic components, for example, solar cells, which comprise at least one organic material, for example at least one organic p-semiconducting material and/or at least one organic dye. By way of example, such effects, as is explained in even greater detail below by way of example, were observed in the case of dye solar cells, that is to say components which have at least one first electrode, at least one n-semiconducting metal oxide, at least one dye, at least one p-semiconducting organic material, preferably a solid organic p-type semiconductor, and at least one second electrode. Such dye solar cells, preferably solid dye solar cells (solid dye sensitized solar cells, sDSC), are known in principle in numerous variations from the literature. The described effect of the dependence of the sensor signal on a geometry of the illumination on the sensor area and a use of this effect have not, however, been described heretofore.

In particular, the optical sensor can be designed in such a way that the sensor signal, given the same total power of the illumination, is substantially independent of a size of the sensor region, in particular of a size of the sensor area, in particular as long as the light spot of the illumination lies completely within the sensor region, in particular the sensor area. Consequently, the longitudinal sensor signal can be dependent exclusively on a focusing of the electromagnetic rays on the sensor area. In particular the sensor signal can be embodied in such a way that a photocurrent and/or a photo voltage per sensor area have/has the same values given the same illumination, for example the same values given the same size of the light spot.

The evaluation device can comprise in particular at least one data processing device, in particular an electronic data processing device, which can be designed to generate the at least one item of information on the transversal position of the object by evaluating the at least one transversal sensor signal and to generate the at least one item of information on the longitudinal position of the object by evaluating the at least one longitudinal sensor signal. Thus, the evaluation device is designed to use the at least one transversal sensor signal and the at least one longitudinal sensor signal as input variables and to generate the items of information on the transversal position and the longitudinal position of the object by processing these input variables. The processing can be done in parallel, subsequently or even in a combined manner. The evaluation device may use an arbitrary process for generating these items of information, such as by calculation and/or using at least one stored and/or known relationship. Besides the at least one transversal sensor signal and at least one longitudinal sensor signal, one or a plurality of further parameters and/or items of information can influence said relationship, for example at least one item of information about a modulation frequency. The relationship can be determined or determinable empirically, analytically or else semi-empirically. Particularly preferably, the relationship comprises at least one calibration curve, at least one set of calibration curves, at least one function or a combination of the possibilities mentioned. One or a plurality of calibration curves can be stored for example in the form of a set of values and the associated function values thereof, for example in a data storage device and/or a table. Alternatively or additionally, however, the at least one calibration curve can also be stored for example in parameterized form and/or as a functional equation. Separate relationships for processing the at least one transversal sensor signal into the at least one item of information on the transversal position and for processing the at least one longitudinal sensor signal into the at least one item of information on the longitudinal position may be used. Alternatively, at least one combined relationship for processing the sensor signals is feasible. Various possibilities are conceivable and can also be combined.

By way of example, the evaluation device can be designed in terms of programming for the purpose of determining the items of information. The evaluation device can comprise in particular at least one computer, for example at least one microcomputer. Furthermore, the evaluation device can comprise one or a plurality of volatile or nonvolatile data memories. As an alternative or in addition to a data processing device, in particular at least one computer, the evaluation device can comprise one or a plurality of further electronic components which are designed for determining the items of information, for example an electronic table and in particular at least one look-up table and/or at least one application-specific integrated circuit (ASIC).

As outlined above, the total intensity of total power of the light beam is often unknown, since this total power e.g. may depend on the properties of the object, such as reflecting properties, and/or may depend on a total power of an illumination source and/or may depend on a large number of environmental conditions. Since the above-mentioned known relationship between the at least one longitudinal optical sensor signal and a beam cross-section of the light beam in the at least one sensor region of the at least one longitudinal optical sensor and, thus, a known relationship between the at least one longitudinal optical sensor signal and the at least one item of information on the longitudinal position of the object may depend on the total power of total intensity of the light beam, various ways of overcoming this uncertainty are feasible. Thus, as outlined in great detail in WO 2012/110924 A1, a plurality of longitudinal sensor signals may be detected by the same optical sensor, such as by using different modulation frequencies of an illumination of the object. Thus, at least two longitudinal sensor signals may be acquired at different frequencies of a modulation of the illumination, wherein, from the at least two sensor signals, for example by comparison with corresponding calibration curves, it is possible to deduce the total power and/or the geometry of the illumination, and/or therefrom, directly or indirectly, to deduce the at least one item of information on the longitudinal position of the object. In addition, it may also be sufficient for the evaluation to know only a relative movement with respect to a position at a time interval before or later. As an example, for deriving a specific gesture as described above it may not be necessary to know the absolute position of the object but to rely on the relative movement of the object with respect to the image plane of the optical sensor.

The detector described can advantageously be developed in various ways. Thus, the detector can furthermore have at least one modulation device for modulating the illumination, in particular for periodic modulation, in particular a periodic beam interrupting device. A modulation of the illumination should be understood to mean a process in which a total power of the illumination is varied, preferably periodically, in particular with one or a plurality of modulation frequencies. In particular, a periodic modulation can be effected between a maximum value and a minimum value of the total power of the illumination. The minimum value can be 0, but can also be >0, such that, by way of example, complete modulation does not have to be effected. The modulation can, thus, be effected in a beam path between the optional illumination source for illuminating the object and the object, for example by the at least one modulation device being arranged in said beam path. A combination of these possibilities is also conceivable. The at least one modulation device can comprise for example a beam chopper or some other type of periodic beam interrupting device, for example comprising at least one interrupter blade or interrupter wheel, which preferably rotates at constant speed and which can thus periodically interrupt the illumination. It may also possible to use one or a plurality of different types of modulation devices, for example modulation devices based on an electro-optical effect and/or an acousto-optical effect. Preferably, the at least one optional illumination source itself can also be designated to generate a modulated illumination, for example by said illumination source itself having a modulated intensity and/or total power, for example a periodically modulated total power, and/or by said illumination source being embodied as a pulsed illumination source, for example as a pulsed light-emitting diode. Thus, by way of example, the at least one modulation device can also be wholly or partly integrated into the illumination source. Various possibilities are conceivable.

The detector can be designed in particular to detect at least two sensor signals in the case of different modulations, in particular at least two sensor signals at respectively different modulation frequencies. The evaluation device can be designed to generate the geometrical information from the at least two sensor signals. As described above, in this way, by way of example, it is possible to resolve ambiguities and/or it is possible to take account of the fact that, for example, a total power of the illumination is generally unknown.

As explained above, the optical sensor can furthermore be designed in such a way that the sensor signal, given the same total power of the illumination, is dependent on a modulation frequency of a modulation of the illumination. The detector can be embodied, in particular, as explained above, in such a way that sensor signals at different modulation frequencies are picked up, for example in order to generate one or a plurality of further items of information about the object. As described above, by way of example, a sensor signal at at least two different modulation frequencies can, in each case, be picked up, wherein, by way of example, in this way, a lack of information about a total power of the illumination can be supplemented. By way of example, by comparing the at least two sensor signals picked up at different modulation frequencies with one or a plurality of calibration curves, which can be stored for example in a data storage device of the detector, even in the case of an unknown total power of the illumination, it is possible to deduce a geometry of the illumination, for example a diameter or an equivalent diameter of a light spot on the sensor area. For this purpose, by way of example, it is possible to use the at least one evaluation device described above, for example at least one data processing data, which can be designed to control such picking-up of sensor signals at different frequencies and which can be designed to compare said sensor signals with the at least one calibration curve in order to generate therefrom the geometrical information, for example information about a geometry of the illumination, for example information about a diameter or equivalent diameter of a light spot of the illumination on a sensor area of the optical sensor. Furthermore, as is explained in even greater detail below, the evaluation device can alternatively or additionally be designed to generate at least one item of geometrical information about the object, for example at least one item of location information. This generation of the at least one item of geometrical information, as explained above, can be effected for example taking account of at least one known relationship between a positioning of the object relative to the detector or a part thereof and a size of a light spot, for example empirically, semi-empirically or analytically using corresponding imaging equations.

In contrast to known detectors, in which a spatial resolution and/or imaging of objects is also generally tied to the fact that the smallest possible sensor areas are used, for example the smallest possible pixels in the case of CCD chips, the sensor region of the proposed detector can be embodied in a very large fashion, in principle, since for example the geometrical information, in particular the at least one item of location information, about the object can be generated from a known relationship for example between the geometry of the illumination and the sensor signal. Accordingly, the sensor region can have for example a sensor area, for example an optical sensor area which is of at least 10 cm², preferably of at least 25 cm², such as a sensor area of 25 cm² to 10 m², preferably a sensor area of 50 cm² to 1 m². The sensor area can generally be adapted to the application. The sensor area preferably may have a rectangular geometry, such as a 16:9 or a 4:3 geometry, particularly adapted to the display for which it may be employed as proximity sensor. However, other geometries and/or sensor areas are feasible. Within this regard, the sensor area should be chosen in such a way that, at least if the object is situated within a visual range of the detector, preferably within a predefined viewing angle and/or a predefined distance from the detector, the light spot is always arranged within the sensor area. In this way, it can be ensured that the light spot is not trimmed by the limits of the sensor region, as a result of which signal corruption could occur.

As described above, the sensor region can be in particular a continuous sensor region, in particular a continuous sensor area, which can preferably generate a uniform, in particular a single, sensor signal. Consequently, the sensor signal can be in particular a uniform sensor signal for the entire sensor region, that is to say a sensor signal to which each partial region of the sensor region contributes, for example additively. The sensor signal can generally, as explained above, in particular be selected from the group consisting of a photocurrent and a photo voltage.

The optical sensor can comprise in particular at least one semiconductor detector and/or be at least one semiconductor detector. In particular, the optical sensor can comprise at least one organic semiconductor detector or be at least one organic semiconductor detector, that is to say a semiconductor detector comprising at least one organic semiconducting material and/or at least one organic sensor material, for example at least one organic dye. Preferably, the organic semiconductor detector can comprise at least one organic solar cell and particularly preferably a dye solar cell, in particular a solid dye solar cell. Exemplary embodiments of such preferred solid dye solar cells are explained in even greater detail below.

In particular, the optical sensor can comprise at least one first electrode, at least one n-semiconducting metal oxide, at least one dye, at least one p-semiconducting organic material, preferably at least one solid p-semiconducting organic material, and at least one second electrode. Generally, however, it is pointed out that the described effect in which the sensor signal, given a constant total power, is dependent on a geometry of the illumination of the sensor region is with high probability not restricted to organic solar cells and in particular not to dye solar cells. Without intending to restrict the scope of protection of the invention by this theory, and without the invention being bound to the correctness of this theory, it is supposed that generally photovoltaic elements are suitable as optical sensors which may operate according to the theory as described in more detail in WO 2014/097181 A1.

The detector has, as described above, at least one evaluation device. In particular, the at least one evaluation device can also be designed to completely or partly control or drive the detector, for example by the evaluation device being designed to control one or a plurality of modulation devices of the detector and/or to control at least one illumination source of the detector. The evaluation device can be designed, in particular, to carry out at least one measurement cycle in which one or a plurality of sensor signals, such as a plurality of transversal sensor signals and/or a plurality of longitudinal sensor signals, are picked up, for example a plurality of sensor signals of successively at different modulation frequencies of the illumination.

The evaluation device is designed, as described above, to generate at least one item of information on a transversal position of the object by evaluating the transversal sensor signal and to generate at least one item of information on a longitudinal position of the object by evaluating the longitudinal sensor signal. Said position of the object can be static but may, preferably, comprise at least one movement of the object, for example a relative movement between the detector or parts thereof, such as the image plane of the optical sensor, and the object or parts thereof. In this case, a relative movement can generally comprise at least one linear movement and/or at least one rotational movement. Items of movement information can for example also be obtained by comparison of at least two items of information picked up at different times, such that for example at least one item of location information can also comprise at least one item of velocity information and/or at least one item of acceleration information, for example at least one item of information about at least one relative velocity between the object or parts thereof and the detector or parts thereof. In particular, the at least one item of location information can generally be selected from: an item of information about a distance between the object or parts thereof and the detector or parts thereof, in particular an optical path length; an item of information about a positioning of the object or parts thereof relative to the detector or parts thereof; an item of information about an orientation of the object and/or parts thereof relative to the detector or parts thereof; an item of information about a relative movement between the object or parts thereof and the detector or parts thereof; an item of information about a two-dimensional or three-dimensional spatial configuration of the object or of parts thereof, in particular a geometry or form of the object. Generally, the at least one item of location information can therefore be selected for example from the group consisting of: an item of information about at least one location of the object or at least one part thereof; information about at least one orientation of the object or a part thereof; an item of information about a geometry or form of the object or of a part thereof, an item of information about a velocity of the object or of a part thereof, an item of information about an acceleration of the object or of a part thereof, an item of information about a presence or absence of the object or of a part thereof in a visual range of the detector. Herein, the at least one item of location information can be specified for example in at least one coordinate system, for example a coordinate system in which the detector or parts thereof rest. Alternatively or additionally, the location information can also simply comprise for example a distance between the detector or parts thereof and the object or parts thereof. Combinations of the possibilities mentioned are also conceivable.

As outlined above, the detector may comprise at least one illumination source. The illumination source can be embodied in various ways. Thus, the illumination source can be for example part of the detector in a detector housing. Alternatively or additionally, however, the at least one illumination source can also be arranged outside a detector housing, for example as a separate light source. The illumination source can be arranged separately from the object and illuminate the object from a distance. Alternatively or additionally, the illumination source can also be connected to the object or even be part of the object, such that, by way of example, the electromagnetic radiation emerging from the object can also be generated directly by the illumination source. By way of example, at least one illumination source can be arranged on and/or in the object and directly generate the electromagnetic radiation by means of which the sensor region is illuminated. By way of example, at least one infrared emitter and/or at least one emitter for visible light and/or at least one emitter for ultraviolet light can be arranged on the object. By way of example, at least one light emitting diode and/or at least one laser diode can be arranged on and/or in the object. The illumination source can comprise in particular one or a plurality of the following illumination sources: a laser, in particular a laser diode, although in principle, alternatively or additionally, other types of lasers can also be used; a light emitting diode; an incandescent lamp; an organic light source, in particular an organic light emitting diode. Alternatively or additionally, other illumination sources can also be used. It is particularly preferred if the illumination source is designed to generate one or more light beams having a Gaussian beam profile, as is at least approximately the case for example in many lasers. However, other embodiments are also possible, in principle.

As outlined above, a further aspect of the present invention proposes a human-machine interface for exchanging at least one item of information between a user and a machine. A human-machine interface should generally be understood to mean a device by means of which such information can be exchanged. The machine can comprise in particular a data processing device. The at least one item of information can generally comprise for example data and/or control commands. Thus, the human-machine interface can be designed in particular for the inputting of control commands by the user.

The human-machine interface has at least one detector in accordance with one or a plurality of the embodiments described above. The human-machine interface is designed to generate at least one item of geometrical information of the user by means of the detector wherein the human-machine interface is designed to assign to the geometrical information at least one item of information, in particular at least one control command. By way of example, said at least one item of geometrical information can be or comprise an item of location information and/or position information and/or orientation information about a body and/or at least one body part of the user, for example an item of location information about a hand posture and/or a posture of some other body part of the user.

In this case, the term user should be interpreted broadly and can for example also encompass one or a plurality of articles directly influenced by the user. Thus, the user can for example also wear one or a plurality of gloves and/or other garments, wherein the geometrical information is at least one item of geometrical information of this at least one garment. By way of example, such garments can be embodied as reflective to a radiation emerging from at least one illumination source, for example by the use of one or a plurality of reflectors. Once again alternatively or additionally, the user can for example spatially move one or a plurality of articles whose geometrical information can be detected, which is likewise also intended to be subsumable under generation of at least one item of geometrical information of the user. By way of example, the user can move at least one reflective rod and/or some other type of article, for example by means of said user's hand.

The at least one item of geometrical information can be static, that is to say can for example once again comprise a snapshot, but can, preferably, once again comprise a series of sequential items of geometrical information and/or at least one movement. By way of example, at least two items of geometrical information picked up at different times can be compared, such that, by way of example, the at least one item of geometrical information can also comprise at least one item of information about a velocity and/or an acceleration of a movement. Accordingly, the at least one item of geometrical information can for example comprise at least one item of information about at least one body posture and/or about at least one movement of the user.

The human-machine interface is designed to assign to the geometrical information at least one item of information, in particular at least one control command. As explained above, the term information should in this case be interpreted broadly and can comprise for example data and/or control commands. By way of example, the human-machine interface can be designed to assign the at least one item of information to the at least one item of geometrical information, for example by means of a corresponding assignment algorithm and/or a stored assignment specification. By way of example, a unique assignment between a set of items of geometrical information and corresponding items of information can be stored. In this way, for example by means of a corresponding body posture and/or movement of the user, an inputting of at least one item of information can be effected.

Such human-machine interfaces can generally be used in the machine control or else for example in virtual reality. By way of example, industrial controllers, manufacturing controllers, machine controllers in general, robot controllers, vehicle controllers or similar controllers can be made possible by means of the human-machine interface having the one or the plurality of detectors. However, the use of such a human-machine interface in consumer electronics is particularly preferred.

Accordingly, as outlined above, a further aspect of the present invention proposes an entertainment device for carrying out at least one entertainment function, in particular a game. The entertainment function can comprise in particular at least one game function. By way of example, one or a plurality of games can be stored which can be influencable by a user, who in this context is also called a player hereinafter. By way of example, the entertainment device can comprise at least one display device, for example at least one screen and/or at least one projector and/or at least one set of display spectacles.

The entertainment device furthermore comprises at least one human-machine interface in accordance with one or more of the embodiments described above. The entertainment device is designed to enable at least one item of information of a player to be input by means of the human-machine interface. By way of example, the player, as described above, can adopt or alter one or a plurality of body postures for this purpose. This includes the possibility of the player for example using corresponding articles for this purpose, for example garments such as e.g. gloves, for example garments which are equipped with one or a plurality of reflectors for reflecting the electromagnetic radiation of the detector. The at least one item of information can comprise for example, as explained above, one or a plurality of control commands. By way of example, in this way, changes in direction can be performed, inputs can be confirmed, a selection can be made from a menu, specific game options can be initiated, movements can be influenced in a virtual space or similar instances of influencing or altering the entertainment function can be performed.

The above-described detector, the method, the human-machine interface and the entertainment device and also the proposed uses have considerable advantages over the prior art. Thus, generally, a simple and, still, efficient detector for determining a position of at least one object in space may be provided. Therein, as an example, three-dimensional coordinates of an object or part of an object may be determined in a fast and efficient way.

As compared to devices known in the art, which of them are based on complex triangulation methods, the detector as proposed provides a high degree of simplicity, specifically with regard to an optical setup of the detector. Thus, in principle, a simple combination of one, two or more sDSCs and in conjunction with an appropriate evaluation device, is sufficient for high precision position detection. This high degree of simplicity, in combination with the possibility of high precision measurements, is specifically suited for machine control, such as in human-machine interfaces and, more preferably, in gaming. Thus, cost-efficient entertainment devices may be provided which may be used for a large number of gaming purposes.

Thus, the detector according to the present invention may be used in mobile phones, tablet computers, laptops, smart panels or other stationary or mobile computer or communication applications. Thus, the detector is combined with at least one active illumination source, such as a light source emitting light in the visible range or, preferably, in the infrared spectral range, in order to enhance performance. The detector may further be used for surveillance and/or for recording purposes or as input devices to control mobile devices, especially in combination with gesture recognition. Thus, specifically, the detector acting as a human-machine interface, also referred to as an input devices, may be used in mobile applications, such as for controlling other electronic devices or components via the mobile device, such as the mobile phone. As an example, the mobile application including at least one detector may be used for controlling a television set, a game console, a music player or music device or other entertainment devices.

Further, the detector may be used in webcams or other peripheral devices for computing applications. Thus, as an example, the detector may be used in combination with software for imaging, recording, surveillance, scanning, or motion detection. As outlined in the context of the human-machine interface and/or the entertainment device, the detector may be particularly useful for giving commands by facial expressions and/or body expressions. In addition, the detector may be combined with other input generating devices like e.g. mouse, keyboard, touchpad, etc. Further, the detector may be used in applications for gaming, such as by using a webcam. Further, the detector may be used in virtual training applications and/or video conferences. Further, the detector may be used in mobile audio devices, television devices and gaming devices, as partially explained above. Specifically, the detector may be used as controls or control devices for electronic devices, entertainment devices or the like.

Further, the detector may be used for security and surveillance applications. Specifically, the detector may be used for optical encryption. Further, given the ease and accuracy of 3D detection by using the detector, the detector generally may be used for facial, body and person recognition and identification. Therein, the detector may be combined with other detection means for identification or personalization purposes such as passwords, finger prints, iris detection, voice recognition or other means. Thus, generally, the detector may be used in security devices and other personalized applications.

Further, the detector may be used is the fields of medical systems and sports. Thus, in the field of medical technology, surgery robotics, e.g. for use in endoscopes, may be named, since, as outlined above, the detector may require a low volume only and may be integrated into other devices. Further, the detector may be combined with an appropriate monitoring software, in order to enable tracking and analysis of movements, such as gestures.

Further, the detector may be used in the field of gaming. Applications of the detector for giving commands are feasible, such as by using one or more detectors for gesture or facial recognition. The detector may be combined with an active system in order to work under e.g. low light conditions or in other situations in which enhancement of the surrounding conditions is required. Additionally or alternatively, a combination of one or more detectors with one or more IR or VIS light sources is possible, such as with a detection device.

Further uses of the detector according to the present invention may be found in WO 2014/097181 A1.

As outlined above, preferably, the at least one optical sensor may comprise at least one organic semiconductor detector, particularly preferably at least one dye solar cell, DSC or sDSC. In particular, the optical sensor each may comprise at least one first electrode, at least one n-semiconducting metal oxide, at least one dye, at least one p-semiconducting organic material and at least one second electrode, preferably in the stated order. The stated elements can be present as layers in a layer construction, for example. The layer construction can be applied for example to a substrate, preferably a transparent substrate, for example a glass substrate.

Preferred embodiments of the above-mentioned elements of the preferred optical sensor are described in WO 2014/097181 A1 by way of example, wherein these embodiments can be used in any desired combination. However, numerous other configurations are also possible, in principle, wherein reference can be made for example to WO 2012/110924 A1, US 2007/0176165 A1, U.S. Pat. No. 6,995,445 B2, DE 2501124 A1, DE 3225372 A1 and WO 2009/013282 A1 cited above.

Summarizing, in the context of the present invention, the following embodiments are regarded as particularly preferred:

### Embodiment 1

A detector for determining a position of at least one object with regard to at least one optical sensor, wherein the optical sensor has an image plane, comprising:
at least one illumination source, wherein the illumination source emits at least one light beam, wherein the light beam comprises a component which is parallel to an image plane of at least one optical sensor;
the optical sensor, wherein the optical sensor has a sensor region in the image plane, wherein the optical sensor is adapted to determine a transversal component of the position of the object in an event where the object approaches the optical sensor in a manner that light is scattered from the component of the light beam conducted parallel to the image plane of the optical sensor, the transversal component of the position being a position in the image plane of the optical sensor, the optical sensor being adapted to generate at least one transversal sensor signal from the light scattered from the component of the light beam conducted parallel to the image plane of the optical sensor in the sensor region, wherein the optical sensor is further designed to generate at least one longitudinal sensor signal in a manner dependent on an illumination of the sensor region by light which is scattered from the component of the light beam conducted parallel to the image plane of the optical sensor, wherein the longitudinal sensor signal is dependent on a variation of an intensity of the light which is scattered from the component of the light beam conducted parallel to the image plane of the optical sensor in the sensor region; and
an evaluation device, wherein the evaluation device is designed to generate at least one item of information on a transversal component of a position of the object by evaluating the transversal sensor signal and wherein the evaluation device is further designed to generate at least one item of information on a longitudinal component of a position of the object by evaluating the longitudinal sensor signal.

### Embodiment 2

The detector according to the preceding embodiment, wherein the optical sensor is a photo detector having at least one first electrode, at least one second electrode and at least one photovoltaic material, wherein the photovoltaic material is embedded in between the first electrode and the second electrode, wherein the photovoltaic material is adapted to generate electric charges in response to an illumination of the photovoltaic material with light, wherein the second electrode is a split electrode having at least two partial electrodes.

### Embodiment 3

The detector according to the preceding embodiment, wherein electrical currents through the partial electrodes are dependent on a position of the light beam in the sensor region.

### Embodiment 4

The detector according to the preceding embodiment, wherein the optical sensor is adapted to generate the transversal sensor signal in accordance with the electrical currents through the partial electrodes.

### Embodiment 5

The detector according to any of the two preceding embodiments, wherein the detector, preferably the optical sensor and/or the evaluation device, is adapted to derive the information on the transversal position of the object from at least one ratio of the currents through the partial electrodes.

### Embodiment 6

The detector according to any of the four preceding embodiments, wherein at least four partial electrodes are provided.

### Embodiment 7

The detector according to any of the five preceding embodiments, wherein the second electrode is a split electrode having three, four, or more partial electrodes

### Embodiment 8

The detector according to any of the six preceding embodiments, wherein the photovoltaic material comprises at least one organic photovoltaic material and wherein the optical sensor is an organic photo detector.

### Embodiment 9

The detector according to any of the seven preceding embodiments, wherein the organic photo detector is a dye-sensitized solar cell.

### Embodiment 10

The detector according to the preceding embodiment, wherein the dye-sensitized solar cell is a solid dye-sensitized solar cell, comprising a layer setup embedded in between the first electrode and the second electrode, the layer setup comprising at least one n-semiconducting metal oxide, at least one dye, and at least one solid p-semiconducting organic material.

### Embodiment 11

The detector according to any of the nine preceding embodiments, wherein the first electrode at least partially is made of at least one transparent conductive oxide, wherein the second electrode at least partially is made of an electrically conductive polymer, preferably a transparent electrically conductive polymer.

### Embodiment 12

The detector according to the preceding embodiment, wherein the conductive polymer is selected from the group consisting of: a poly-3,4-ethylenedioxythiophene (PEDOT), preferably PEDOT being electrically doped with at least one counter ion, more preferably PEDOT doped with sodium polystyrene sulfonate (PEDOT:PSS); a polyaniline (PANI); a polythiophene.

### Embodiment 13

The detector according to any of the two preceding embodiments, wherein the conductive polymer provides an electric resistivity of 0.1-20 kΩ between the partial electrodes, preferably an electric resistivity of 0.5-5.0 kΩ and, more preferably, an electric resistivity of 1.0-3.0 kΩ.

### Embodiment 14

The detector according to any of the preceding embodiments, wherein the at least one of the optical sensor is a transparent optical sensor.

### Embodiment 15

The detector according to any of the preceding embodiments, wherein one optical sensor is provided.

### Embodiment 16

The detector according to any of the preceding embodiments, wherein the detector furthermore has at least one modulation device for modulating the illumination.

### Embodiment 17

The detector according to the preceding embodiment, wherein the detector is designed to detect at least two longitudinal sensor signals in the case of different modulations, in particular at least two sensor signals at respectively different modulation frequencies, wherein the evaluation device is designed to generate the at least one item of information on the longitudinal position of the object by evaluating the at least two longitudinal sensor signals.

### Embodiment 18

The detector according to any of the preceding embodiments, wherein the optical sensor is furthermore designed in such a way that the longitudinal sensor signal, given the same total power of the illumination, is dependent on a modulation frequency of a modulation of the illumination.

### Embodiment 19

The detector according to any of the preceding embodiments, wherein the sensor region of the optical sensor is exactly one continuous sensor region, wherein the sensor signal is a uniform sensor signal for the entire sensor region.

### Embodiment 20

The detector according to any of the preceding embodiments, wherein the sensor region of the optical sensor is or comprises a sensor area, the sensor area being formed by a surface of the respective device, wherein the surface faces towards the object or faces away from the object.

### Embodiment 21

The detector according to any of the preceding embodiments, wherein the longitudinal sensor signal is selected from the group consisting of a current and a voltage.

### Embodiment 22

The detector according to any of the preceding embodiments, wherein the transversal sensor signal is selected from the group consisting of a current and a voltage or any signal derived thereof.

### Embodiment 23

The detector according to any of the preceding embodiments, wherein the evaluation device is designed to generate the at least one item of information on the longitudinal position of the object from at least one predefined relationship between the geometry of the illumination and a relative positioning of the object with respect to the detector, preferably taking account of a known power of the illumination and optionally taking account of a modulation frequency with which the illumination is modulated.

### Embodiment 24

The detector according to the preceding embodiment, wherein the evaluation device is adapted to normalize the longitudinal sensor signals and to generate the information on the longitudinal position of the object independent from an intensity of the light beam.

### Embodiment 25

The detector according to any of the two preceding embodiments, wherein the evaluation device is adapted to recognize whether the light beam widens or narrows, by comparing the longitudinal sensor signals of different optical sensors.

### Embodiment 26

The detector according to any of the preceding embodiments, wherein the evaluation device is adapted to generate the at least one item of information on the longitudinal position of the object by determining a diameter of the light beam from the at least one longitudinal sensor signal.

### Embodiment 27

The detector according to the preceding embodiment, wherein the evaluation device is adapted to compare the diameter of the light beam with known beam properties of the light beam in order to determine the at least one item of information on the longitudinal position of the object, preferably from a known dependency of a beam diameter of the light beam on at least one propagation coordinate in a direction of propagation of the light beam and/or from a known Gaussian profile of the light beam.

### Embodiment 28

The detector according to any of the preceding embodiments, wherein the illumination source is connected with the optical sensor.

### Embodiment 29

The detector according to any of the preceding embodiments, wherein the illumination source is located on a side of the optical sensor.

### Embodiment 30

The detector according to any of the preceding embodiments, wherein the detector comprises at least two separate illumination sources.

### Embodiment 31

The detector according to the preceding embodiment, wherein the at least two illumination sources form a frame which fully or partially encloses the image plane and/or the optical sensor.

### Embodiment 32

The detector according to any of the preceding embodiments, wherein the detector further comprises at least one modulation device for modulating the illumination of the at least one light beam emitted by the illumination source.

### Embodiment 33

The detector according to any of the preceding embodiments, wherein the detector further comprises at least one modulation device for modulating the illumination of the at least one light beam emitted by the illumination source.

### Embodiment 34

The detector according to any of the preceding embodiments, wherein the detector further comprises at least one modulation device for modulating the illumination of the at least one light beam emitted by the illumination source.

### Embodiment 35

The detector according to any of the two preceding embodiments, wherein at least two separate illumination sources are present, wherein the separate illumination source differ by a frequency used for modulating the illumination of each illumination source.

### Embodiment 36

The detector according to any of the preceding embodiments, wherein the evaluation device is further designated to combine at least two different items of information on a position of the object into a specific command.

### Embodiment 37

The detector according to the preceding embodiment, wherein the specific command is interpreted as a gesture.

### Embodiment 38

The detector according to the preceding embodiment, wherein the gesture comprises a function selected from a click, a double click, a rotation, a zoom function, and a drag-and-drop movement.

### Embodiment 39

A human-machine interface for exchanging at least one item of information between a user and a machine, in particular for inputting control commands, wherein the human-machine interface comprises at least one detector according to any of the preceding embodiments relating to a detector, wherein the human-machine interface is designed to generate at least one item of geometrical information of the user by means of the detector wherein the human-machine interface is designed to assign to the geometrical information at least one item of information, in particular at least one control command.

### Embodiment 40

The human-machine interface according to the preceding embodiment, wherein the at least one item of geometrical information of the user is selected from the group consisting of: a position of at least one body part of the user; an orientation of at least one body part of the user; a motion of at least one body part of the user.

### Embodiment 41

The human-machine interface according to any one of the two preceding embodiments, wherein the human-machine interface further comprises at least one display, wherein the optical sensor is transparent and/or translucent and is located with respect to the display in a manner that the display is fully or partially visible through the optical sensor.

### Embodiment 42

The human-machine interface according to the preceding embodiment, wherein the display is a dynamic display, preferably a display selected from a cathode ray tube (CRT), a liquid crystal display (LCD), a plasma screen, a light-emitting diode (LED) screen, an organic light-emitting diode (OLED) screen, and a field emission display (FED).

### Embodiment 43

An entertainment device for carrying out at least one entertainment function, in particular a game, wherein the entertainment device comprises at least one human-machine interface according to any of the preceding embodiments referring to a human-machine interface, wherein the entertainment device is designed to enable at least one item of information to be input by a player by means of the human-machine interface, wherein the entertainment device is designed to vary the entertainment function in accordance with the information.

### Embodiment 44

A method for determining a component of a position of at least one object with regard to at least one optical sensor, wherein the optical sensor has an image plane, in particular using a detector according to any of the preceding embodiments relating to a detector,
wherein at least one illumination source is used, wherein the at least one illumination source emits at least one light beam, wherein the light beam comprises a component which is parallel to an image plane of at least one optical sensor;
wherein at least one optical sensor of a detector is used, wherein the optical sensor has a sensor region in the image plane, wherein the optical sensor is adapted to determine a transversal component of the position of the object in an event where the object approaches the optical sensor in a manner that light is scattered from the component of the light beam conducted parallel to the image plane of the optical sensor, the transversal component of the position being a position in the image plane of the optical sensor, the optical sensor being adapted to generate at least one transversal sensor signal from the light scattered from the component of the light beam conducted parallel to the image plane of the optical sensor in the sensor region, wherein the optical sensor is further designed to generate at least one longitudinal sensor signal in a manner dependent on an illumination of the sensor region by light which is scattered from the component of the light beam conducted parallel to the image plane of the optical sensor, wherein the longitudinal sensor signal is dependent on a variation of an intensity of the light which is scattered from the component of the light beam conducted parallel to the image plane of the optical sensor in the sensor region;
wherein at least one evaluation device is used, wherein the evaluation device is designed to generate at least one item of information on a transversal component of a position of the object by evaluating the transversal sensor signal and wherein the evaluation device is further designed to generate at least one item of information on a longitudinal component of a position of the object by evaluating the longitudinal sensor signal.

### Embodiment 45

The use of a detector according to any of the preceding embodiments relating to a detector, for a purpose of use, selected from the group consisting of: a position measurement, in particular as a proximity sensor; a distance measurement, in particular as a proximity sensor; a human-machine interface application; an entertainment application; a security application.

### BRIEF DESCRIPTION OF THE FIGURES

Further optional details and features of the invention are evident from the description of preferred exemplary embodiments which follows in conjunction with the dependent claims. In this context, the particular features may be implemented alone or with several in combination. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIGS. 1A to 1C shows exemplary embodiments of a detector, including a human-machine interface, according to the present invention;

FIGS. 2A and 2B show different views of an embodiment of a detector which may be used in the detector of the present invention;

FIGS. 3A to 3D show principles of generating sensor signals and deriving information on a transversal position of an object;

FIGS. 4A and 4B show different views of embodiments of an optical sensor which may be used in the detector according to the present invention; and

FIGS. 5A to 5E show the principle of generating longitudinal sensor signals and deriving information on a longitudinal position of an object.

### EXEMPLARY EMBODIMENTS

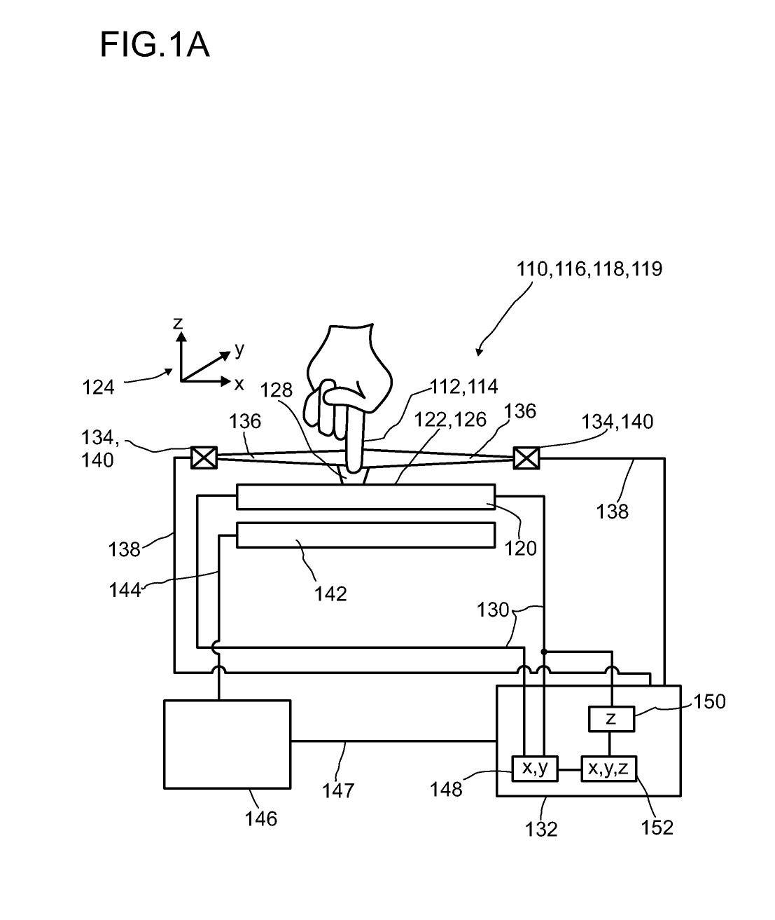

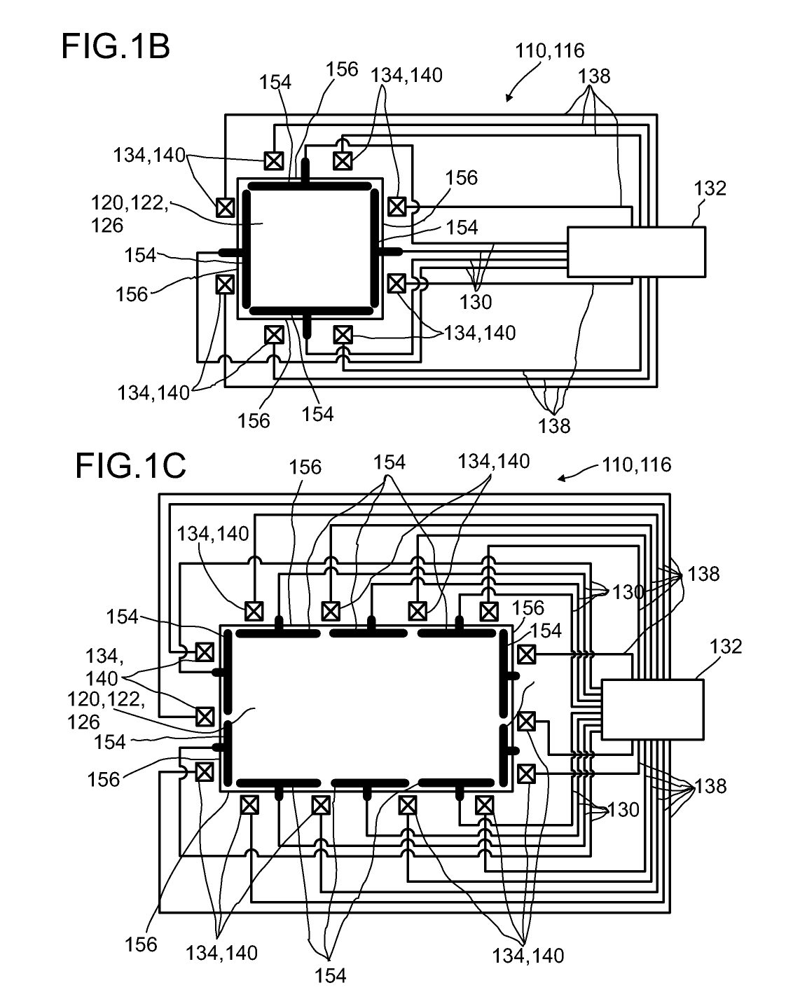

FIG. 1A illustrates, in a highly schematic illustration, a side view of an exemplary embodiment of a detector 110 according to the invention, for determining a position of at least one object 112, in particular a finger 114 of a user. The detector 110 may preferably form a proximity sensor 116 or may, thus, be part of a human-machine interface 118, wherein the human-machine-interface may be used in an entertainment-device 119. However, other embodiments are feasible.

The detector 110 comprises an optical sensor 120, which exhibits an image plane 122. Specifically, the image plane 122 the image plane here defines a kind of a natural coordinate system 124 with respect to the optical sensor 120 as symbolically depicted in FIG. 1A. Herein the image plane 122 is considered as the x-y plane and a direction perpendicular thereof is denoted the z direction. In this coordinate system 124, a direction parallel or antiparallel to the x-y plane is regarded as comprising a transversal component and a coordinate along the z-axis is considered a longitudinal coordinate. An arbitrary direction perpendicular to the longitudinal direction is, thus, considered comprising a transversal component and an x- and/or y-coordinate is considered as a transversal coordinate. Other types of coordinate systems 124 are feasible.

The optical sensor 120 comprises a sensor region 126, which is transparent to an incident scattered light beam 128 which travels after scattering by the object 112 from the object 112 to the detector 110. The optical sensor 120 is adapted to determine a transversal position of the light beam 128 in one or more transversal directions, such as in direction x and/or in direction y. Thus, the optical sensor 120 is adapted to generate at least one transversal sensor signal. In addition, the optical sensor 120 is further designated to generate at least one longitudinal sensor signal in a manner dependent on an illumination of the respective sensor region 126 by the light beam 128. The longitudinal sensor signals, given the same total power of the illumination, is dependent on a beam cross-section of the light beam 128 in the respective sensor region 126, as will be outlined in further detail below. Both the transversal sensor signal and the longitudinal sensor signal is transmitted by one or more signal leads 130 to at least one evaluation device 132 of the detector 110.

In addition, the detector shown in FIG. 1A comprises two separate illumination sources 134, wherein each illumination source 134 emits at least one primary light beam 136, wherein each primary light beam 136 comprises a component which is parallel to the image plane 122 of the optical sensor 120. In this particular example, the evaluation device 132 further comprises illumination leads 138, where each illumination lead 138 may transmit control signals from the evaluation device 132 to each illumination source 134 in order to control their operation. In addition, the illumination sources may, preferably, be equipped with a modulation device 140, which may affect the longitudinal sensor signal in a manner that, given the same total power of the illumination, the longitudinal sensor signal is dependent on a modulation frequency of a modulation of the illumination. However, other embodiments are feasible, such as where the detector 110 comprises a separate modulation device 140.

As shown in FIG. 1A, the optical sensor 120 is adapted to determine a transversal component of the position of the finger 114 of the user in an event where the finger 114 as the object 112 approaches the optical sensor 120 in a manner that the incident light beam 128 is generated from the component of the incident primary light beam 136 which is conducted parallel to the image plane 122 of the optical sensor 120 and which is scattered by the finger 114 of the user. Accordingly, the optical sensor 120 is adapted to generate at least one transversal sensor signal from light of the scattered light beam 128 which impinges the image plane 122 of the optical sensor 120 in the sensor region 126.

Further, the optical sensor 120 is designated to generate at least one longitudinal sensor signal in a manner dependent on an illumination of the sensor region 126 by the light beam 128 being scattered from the component of the primary light beam 136 conducted parallel to the image plane of the optical sensor 120. Herein, the longitudinal sensor signal is dependent on a variation of an intensity of the light of the scattered light beam 128 which impinges the image plane 122 of the optical sensor 120 in the sensor region 126.

As further depicted in FIG. 1A, the human-machine interface 118 which is adapted for exchanging at least one item of information between a user and a machine comprises at least one detector 110 as described above and, in addition, a display 142. In particular for achieving a sufficient illumination of the display 142, the optical sensor 120 is transparent and/or translucent and is located with respect to the display 142 in a manner that the display 142 is fully or partially visible through the optical sensor 120. In particular, the display is a dynamic display, preferably a display selected from a cathode ray tube (CRT), a liquid crystal display (LCD), a plasma screen, a light-emitting diode (LED) screen, an organic light-emitting diode (OLED) screen, and a field emission display (FED).

The human-machine interface 118 is designated to generate at least one item of geometrical information of the object 112 related to the user 200 by means of the detector 110. For this purpose, the display 142 is equipped with a display lead 144 which is adapted for transmitting information to a control device 146 which may be part of the human-machine interface 118. However, other embodiments are possible. Furthermore, in particular to enable a communication between the evaluation device 132 of the detector 110 and the control device 146 of the human-machine interface 118, an evaluation lead 147 is provided in order to exchange information between the evaluation device 132 and the control device 146, preferably in a unidirectional way from the evaluation device 132 to the control device 146; however, a bidirectional exchange of information between the evaluation device 132 and the control device 146 may also be feasible in certain embodiments.

As will be outlined in further detail below, the evaluation device may be designed to generate at least one item of information on at least one transversal position of the object 112 by evaluating the at least one transversal sensor signal and to generate at least one item of information on at least one longitudinal position of the object 112 by evaluating the longitudinal sensor signal. For this purpose, the evaluation device 132 may comprise one or more electronic devices and/or one or more software components, in order to evaluate the sensor signals, which is symbolically denoted by transversal evaluation unit 148 (denoted by “xy”) and longitudinal evaluation unit 150 (denoted by “z”). By combining results derived by these evolution units 148, 150, a position information 152, preferably a three-dimensional position information, symbolically denoted here by “x, y, z”, may thus be generated.

The evaluation device 132 may be part of a data processing device and/or may comprise one or more data processing devices. The evaluation device 132 may be fully or partially integrated into a housing and/or may fully or partially be embodied as a separate device which is electrically connected in a wireless or wire-bound fashion to the optical sensor 120. The evaluation device 132 may further comprise one or more additional components, such as one or more electronic hardware components and/or one or more software components, such as one or more measurement units (not depicted in FIG. 1A) and/or one or more transformation units, such as to transform sensor signals from more than one optical sensor 120 (not depicted here) into a common signal or a common information.

In FIGS. 1B and 1C, different views of a potential embodiment of the detector 110, which may preferably used as a proximity sensor 116, are depicted. Therein, both FIGS. 1B and 1C show a top view of the optical sensor 120, wherein the optical sensor 120 is surrounded by a number of separate illumination sources 134. As two typical examples, eight separate illumination sources 134 are placed around the optical sensor 120 in FIG. 1B and fourteen separate illumination sources 134 the optical 120 sensor in FIG. 1C. However, other embodiments where a different number of separate illumination sources 134 are located around the optical sensor 120 are possible. In addition, FIGS. 1B and 1C schematically depict an arrangement wherein the illumination sources 134 are placed in a quite symmetrical manner more or less equidistant from each other. This kind of arrangement particularly allows a sufficient and rather uniform illumination of the sensor region 126 which is located in the image plane 122 of the optical sensor 120 which, consequently, increases an optical resolution within the sensor region 126 and reduces computation time eventually required for determining necessary corrections, in particular by using the evaluation unit 132.

Whereas the detector 110 as shown in FIG. 1B comprises four separate electrodes 154, wherein each electrode 154 is located near each side 156 of the optical sensor 120, the detector 110 as shown in FIG. 1C comprises ten separate electrodes 154, wherein each electrode 154 is located near the side 156 of the optical sensor 120 in a manner that two or three electrodes 154 are located at the same side 156 of the optical sensor 120. While the arrangement as schematically depicted in FIG. 1B might particularly be useful when the optical sensor 120 exhibits a comparatively small area, in particular at 200 cm² or below, as, for example, used for displays at machines, cellular phones, or smartphones, the arrangement as schematically depicted in FIG. 1C might preferably be applicable when the optical sensor 120 exhibits a comparatively large area, in particular at 0.25 m² or above, as, for example, used for computer monitors, TV sets, information displays. However, other arrangements, even for the given examples, may be feasible, in particular with accordance to specific requirements, such as speed and resolution.

In the embodiments disclosed hereinafter, the optical sensor 120 is designated as solid dye-sensitized solar cells (sDSCs). It shall be noted, however, that other embodiments are feasible.

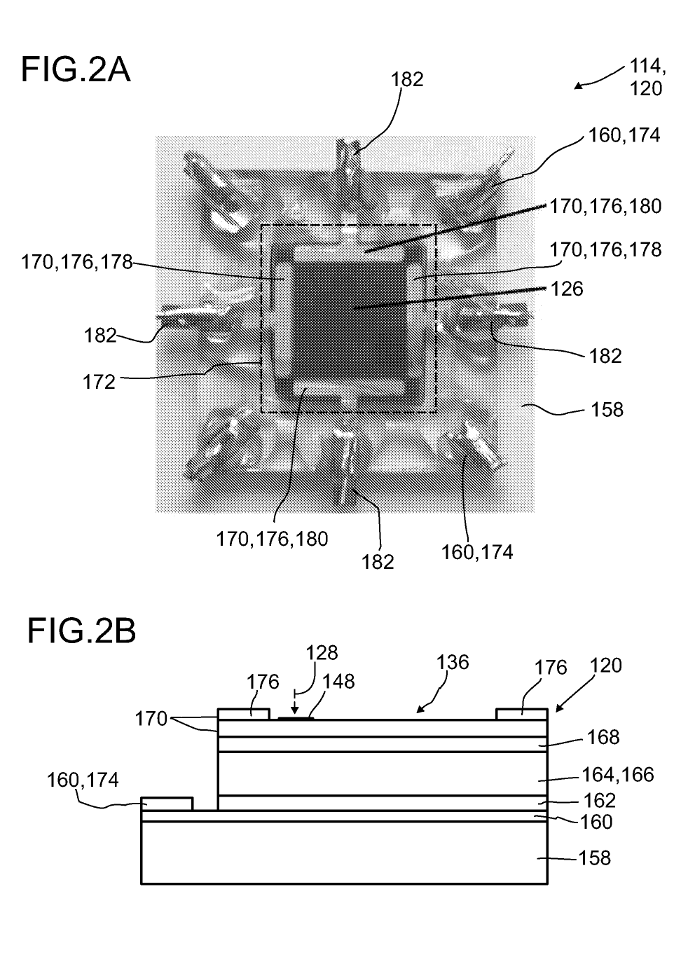

In FIGS. 2A and 2B, different views of a potential embodiment of the optical sensor 120 are depicted. Therein, FIG. 2A shows a top view on a layer setup of the optical sensor 120, whereas FIG. 2B shows a partial cross-sectional view of the layer setup in a schematic setup. For alternative embodiments of the layer setup, reference may be made to the disclosure above.

The optical sensor 120 comprises a transparent substrate 158, such as a substrate made of glass and/or a transparent plastic material. The setup further comprises a first electrode 160, an optical blocking layer 162, at least one n-semiconducting metal oxide 164, sensitized with at least one dye 166, at least one p-semiconducting organic material 168 and at least one second electrode 170. These elements are depicted in FIG. 2B. The setup may further comprise at least one encapsulation 172 which is not depicted in FIG. 2B and which is symbolically depicted in the top-view of FIG. 2A, which may cover a sensor region 126 of the optical sensor 120.

As an exemplary embodiment, the substrate 158 may be made of glass, the first electrode 160 may fully or partially be made of fluorine-doped tin oxide (FTO), the blocking layer 162 may be made of dense titanium dioxide (T102), the n-semiconducting metal oxide 164 may be made of nonporous titanium dioxide, the p-semiconducting organic material 168 may be made of spiro-MiOTAD, and the second electrode 170 may comprise PEDOT:PSS. Further, dye ID504, as e.g. disclosed in WO 2012/110924 A1, may be used. Other embodiments are feasible.

As depicted in FIGS. 2A and 2B, the first electrode 160 may be a large-area electrode, which may be contacted by a single electrode contact 174. As depicted in the top-view in FIG. 2A, the electrode contacts 174 of the first electrode 160 may be located in corners of the optical sensor 120. By providing more than one electrode contact 174, a redundancy may be generated, and resistive losses over the first electrode 160 might be eliminated, thereby generating a common signal for the first electrode 160.

Contrarily, the second electrode 170 comprises at least two partial electrodes 176. As can be seen in the top-view in FIG. 2A, the second electrode 170 may comprise at least two partial electrodes 178 for an x-direction, and at least two partial electrodes 180 for a y-direction via contact leads 182, these partial electrodes 176 may be contacted electrically through the encapsulation 172.

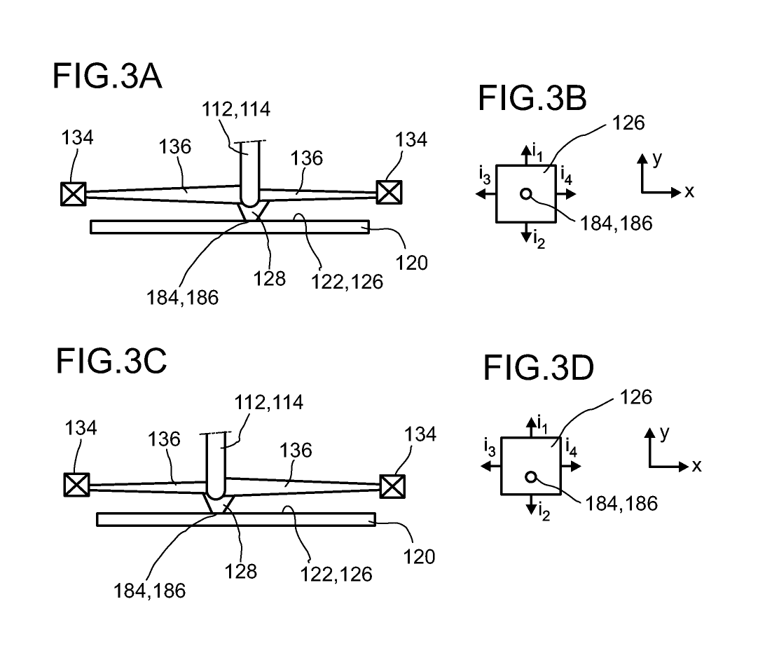

The partial electrodes 176, in this specific embodiment, form a frame which surrounds the sensor region 126. As an example, a rectangular or, more preferably, a square frame may be formed. By using appropriate current measurement devices, electrode currents through the partial electrodes 176 may be determined individually, such as by current measurement devices implemented into the evaluation device 132. By comparing e.g. electrode currents through the two single x-partial electrodes 178 and by comparing the electrode currents through the individual y-partial electrodes 180, x- and y-coordinates of a light spot 184 generated by the incident light beam 128 in the sensor region 126 may be determined, as for the outlined with respect to FIGS. 3A to 3D below.

In FIGS. 3A to 3D, two different situations of a positioning of the finger 114 as the object 112 are depicted. Thus, FIG. 3A and FIG. 3B show a situation in which the object 112 is located on a central optical axis of the detector 110. Therein, FIG. 3A shows a side-view and FIG. 3B shows a top-view onto the sensor region 126 of the optical sensor 120. In FIGS. 3C and 3D, the setup of FIGS. 3A and 3B is depicted in analogous views with the object 112 shifted in a transversal direction, to an off-axis position.

According to the present invention, the optical sensor 120 is adapted to determine a transversal component of the position of the object 112 user in an event where the object 112 approaches the optical sensor 120 such that the incident light beam 128 is generated from the component of the primary light beam 136 conducted parallel to the image plane 122 of the optical sensor 120 and scattered by the object 112. Accordingly, as shown in FIGS. 3A and 3C, the object 112 is imaged onto the sensor region 126 of the optical sensor 120, thereby generating an image 186 of the object 112 on the sensor region 126, which, in the following, will be considered as a light spot 184 or, if more than one objects, such as two or more fingers 114 are present in the proximity of the sensor region 126 of the optical sensor 120, a plurality of light spots 184.

As can be seen in the partial images 3B and 3D, the light spot 184 on the sensor region 126 will lead, by generating charges in the layer setup of the sDSC, electrode currents, which, in each case, are denoted by i₁ to i₄. Therein, electrode currents i₁, i₂ denote electrode currents through partial electrodes 180 in y-direction and electrode currents i₃, i₄ denote electrode currents through partial electrodes 178 in x-direction. These electrode currents may be measured by one or more appropriate electrode measurement devices simultaneously or sequentially. By evaluating these electrode currents, x- and y-coordinates may be determined. Thus, the following equations may be used:

$${x}_{0} = f ( \frac{{i}_{3} - {i}_{4}}{{i}_{3} + {i}_{4}} ) and {y}_{0} = f ( \frac{{i}_{1} - {i}_{2}}{{i}_{1} + {i}_{2}} ) .$$

Therein, f might be an arbitrary known function, such as a simple multiplication of the quotient of the currents with a known stretch factor and/or an addition of an offset. Thus, generally, the electrode currents i₁ to i₄ might form transversal sensor signals generated by the optical sensor 120, whereas the evaluation device 132 might be adapted to generate information on a transversal position, such as at least one x-coordinate and/or at least one y-coordinate, by transforming the transversal sensor signals by using a predetermined or determinable transformation algorithm and/or a known relationship.

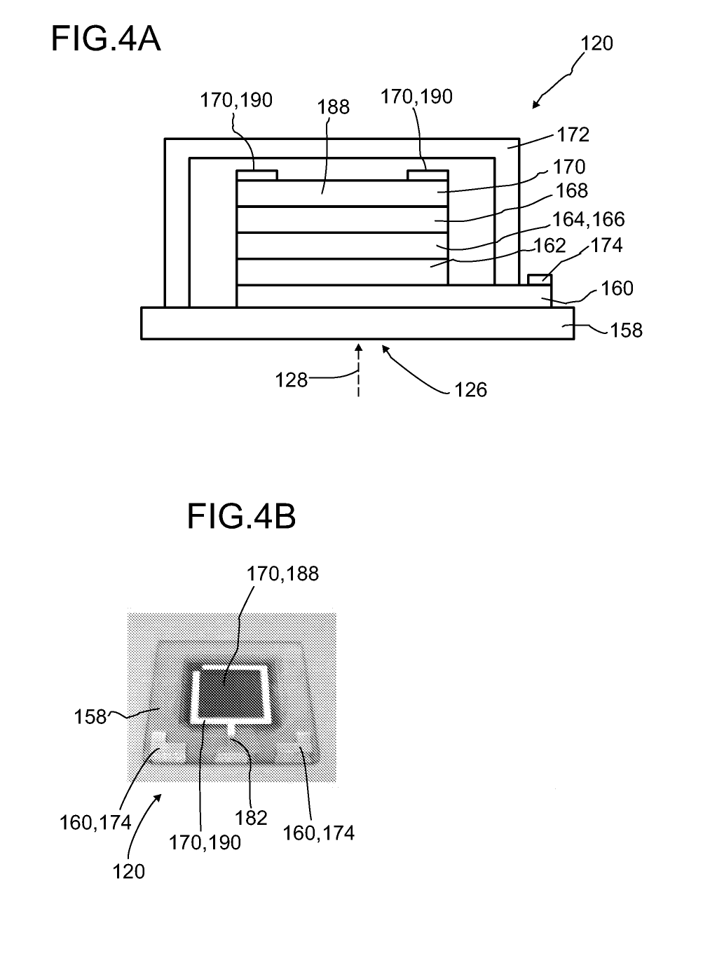

In FIGS. 4A and 4B, views of specific embodiments of the optical sensor 120 are shown. Therein, FIG. 4A shows a cross-sectional view of a potential layer setup, and FIG. 4B shows a top view of two embodiments of the optical sensor 120. Other embodiments are feasible.

As can be seen in the schematic cross-sectional view in FIG. 4A, the optical sensor 120 again, might be embodied as an organic photo-detector, preferably as an sDSC. Thus, similarly to the setup of FIG. 2B, a layer setup using a substrate 158, a first electrode 160, a blocking layer 162, an n-semiconducting metal oxide 164 being sensitized with a dye 166, a p-semiconducting organic material 168 and a second electrode 170 may be used. Additionally, an encapsulation 172 may be provided. For potential materials of the layers, reference may be made to FIG. 2B above. Additionally or alternatively, other types of materials may be used.

It shall be noted that, in FIG. 2B, an illumination from the top is symbolically depicted, i.e. an illumination by the incident light beam 128 from the side of the second electrode 170. Alternatively, an illumination from the bottom, i.e. from the side of the substrate 158 and through the substrate 158, may be used. The same holds true for the setup of FIG. 4A.

However, as depicted in FIG. 4A, in a preferred orientation of the optical sensor 120, an illumination by the incident light beam 128 preferably takes place from the bottom, i.e. through the transparent substrate 158. This is due to the fact that the first electrode 160 may easily be embodied as a transparent electrode, such as by using a transparent conductive oxide, such as FTO. The second electrode 170, as will be outlined in further detail below, may be transparent or intransparent.

In FIG. 4B, a specific setup of the second electrode 170 are depicted. Therein, in FIG. 4B, corresponding to the cross-sectional view of FIG. 4A, the first electrode 160 may be contacted by one or more electrode contacts 174, which, as an example, may comprise one or more metal pads, similar to the setup in FIG. 2B. These electrode contacts 174 may be located in the corners of the substrate 158. Other embodiments are feasible.

The second electrode 170, however, in the setup of FIG. 4B may comprise one or more layers of a transparent electrically conductive polymer 188. As an example, similar to the setup of FIGS. 2A and 2B, PEDOT:PSS may be used. Further, one or more top contacts 190 may be provided, which may be made of a metallic material, such as aluminum and/or silver. By using one or more contact leads 182, leading through the encapsulation 172, this top contact 190 may be electrically contacted.

In the exemplary embodiment shown in FIG. 4B, the top contact 190 forms a closed opened frame surrounding the sensor region 126. Thus, as opposed to the partial electrodes 176 in FIGS. 2A and 2B, only one top contact 190 is required. However, the optical sensor 120 may be combined in one single device, such as by providing partial electrodes in the setup of FIGS. 4A and 4B. Thus, in addition to the FiP effect which will be outlined in further detail below, transversal sensor signals may be generated with the optical sensor 120. The use of the transparent electrically conductive polymer 188 allows for an embodiment of the optical sensor 120 in which both the first electrode 160 and the second electrode 170 are at least partially transparent. The same, preferably, holds true for the optical sensor 120.

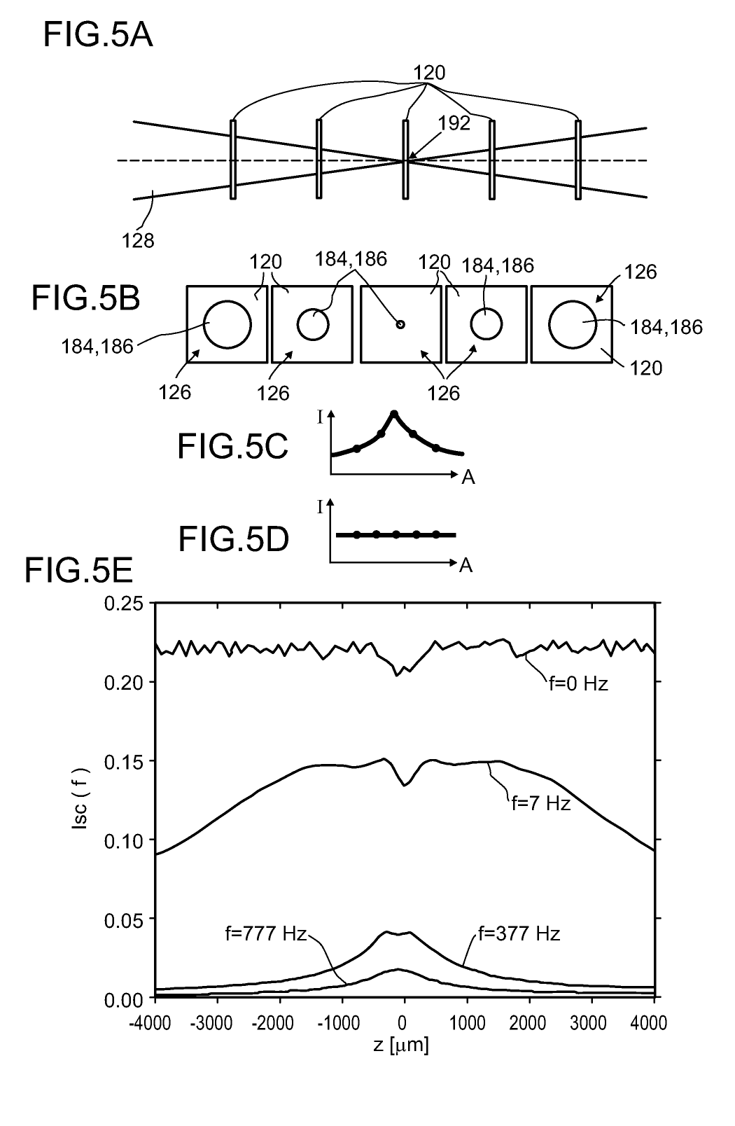

In FIGS. 5A to 5E, the above-mentioned FiP effect shall be explained. Therein, FIG. 5A shows a side-view of a part of a detector 110 similar to the setup in FIGS. 1, 3A and 3C. Of the detector 110, only the optical sensor 120 is depicted, however, at five different positions where it may be located. Again, the measurement starts with a scattering of one or more primary light beams 136 emitted by the at least one illumination source 134 by at least one object 112.

Due to a characteristic of the incident light beam 128, the beam properties of the scattered light beam 128 which incidents the sensor region 126 of the optical sensor 120 is at least partially known. Thus, as depicted in FIG. 5A, a focal point 192 might occur. In the focal point 192, a beam waist or a cross-section of the scattered light beam 128 may assume a minimum value.

In FIG. 5B, in a top-view onto the sensor regions 126 with regard of the respective location of the optical sensor 120 in FIG. 5A, a development of the light spots 184 generated by the incident light beam 128 which impinges the sensor region 126 at the different positions is depicted. As can be seen, close to the focal point 192, the cross-section of the light spot 184 assumes a minimum value.

In FIG. 5C, a photo current I of the optical sensor 120 is given for the five cross-sections of the light spot 184 in FIG. 5B, in case the optical sensor 120 exhibiting the above-mentioned FiP effect is used. Thus, as an exemplary embodiment, five different photo currents I for the spot cross-sections as shown in FIG. 5B are shown for typical DSC devices preferably sDSC devices. The photo current I is depicted as a function of the area A of the light spot 184, which is a measure of the cross-section of the light spots 184.

As can be seen in FIG. 5C, the photo current I, even if the optical sensor 120 is illuminated with the same total power of the illumination, the photo current I is dependent on the cross-section of the incident light beam 128, such as by providing a strong dependency on the cross-sectional area A and/or the beam waist of the light spot 184. Thus, the photo current is a function both of the power of the incident light beam 128 and of the cross-section of the incident light beam 128:

I=f(n,a).

Therein, I denotes the photo current provided by the optical sensor 120, such as a photo current measured in arbitrary units, as a voltage over at least one measurement resistor and/or in amps. n denotes the overall number of photons impinging the sensor region 126 and/or the overall power of the incident light beam 128 in the sensor region 126. A denotes the beam cross-section of the incident light beam 128, provided in arbitrary units, as a beam waist, as a beam diameter of beam radius or as an area of the light spot 184. As an example, the beam cross-section may be calculated by the 1/e² diameter of the light spot 184, i.e. a cross-sectional distance from a first point on a first side of a maximum intensity having an intensity of 1/e² as compared to the maximum intensity of the light spot 184, to a point on the other side of the maximum having the same intensity. Other options of quantifying the beam cross-section are feasible.

The setup in FIG. 5C shows the photo current of a optical sensor 120 according to the present invention which may be used in the detector 110 according to the present invention, showing the above-mentioned FiP effect. Contrarily, FIG. 5D in a diagram corresponding to the diagram of FIG. 5C, photo currents of traditional optical sensors are shown, for the same setup as depicted in FIG. 5A. As an example, silicon photo detectors may be used for this measurement. As can be seen, in these traditional measurements, the photo current or photo signal of the detectors is independent from the beam cross-section A.

Thus, by evaluating the photo currents and/or other types of longitudinal sensor signals of the optical sensor 120 of the detector 110, the incident light beam 128 may be characterized. Since the optical characteristics of the incident light beam 128 depend on the distance of the object 112 from the detector 110, by evaluating these longitudinal sensor signals, a position of the object 112 in the z-position, may be determined. For this purpose, the photo currents of the optical sensor 120 may be transformed, such as by using one or more known relationships between the photo current I and the position of the object 112, into at least one item of information on a longitudinal position of the object 112, in z-position. Thus, as an example, the position of the focal point 192 may be determined by evaluating the sensor signals, and a correlation between the focal point 192 and a position of the object 112 in the z-direction may be used for generating the above-mentioned information. Additionally or alternatively, a widening and/or narrowing of the incident light beam 128 may be evaluated by comparing at least two sensor signals of the optical sensor 120. As an example, known beam properties may be assumed, such as a beam propagation of the incident light beam 128 according to Gaussian laws, using one or more Gaussian beam parameters.

Further, evaluating a number of different longitudinal sensor signals, such as a time sequence, provides additional advantages as opposed to the evaluation of a single longitudinal sensor signal. Thus, as outlined above, the overall power of the incident light beam 128 generally might be unknown. By normalizing the different longitudinal sensor signals, such as to a maximum value, the different longitudinal sensor signals might be rendered independent from the overall power of the incident light beam 128, and a relationship

Iₙ=g(A)

may be used by using normalized photo currents and/or normalized longitudinal sensor signals, which is independent from the overall power of the incident light beam 128.

Additionally, by using a number of longitudinal sensor signals, an ambiguity with regard to the longitudinal sensor signals may be resolved. Thus, as can be seen by comparing the first and the last image in FIG. 5B and/or by comparing the second and the fourth image in FIG. 5B, and/or by comparing the corresponding photo currents in FIG. 5C, the optical sensor 120 being positioned at a specific distance before or behind the focal point 192 may lead to the same longitudinal sensor signals. A similar ambiguity might arise in case the incident light beam 128 weakens during propagations along the optical axis 116, which might generally be corrected empirically and/or by calculation. In order to resolve this ambiguity in the z-position, the plurality of longitudinal sensor signals clearly shows the position of the focal point and of the maximum. Thus, by e.g. comparing with one or more subsequent longitudinal sensor signals, it may be determined whether the optical sensor 120 is located before or beyond a focal point on the longitudinal axis.

In FIG. 5E, a longitudinal sensor signal for a typical example of an sDSC is depicted, in order to demonstrate the possibility of the longitudinal sensor signal and the above-mentioned FiP effect being dependent on a modulation frequency. In this figure, a short-circuit current Isc is given as the longitudinal sensor signal on the vertical axis, in arbitrary units, for a variety of modulation frequencies f. On the horizontal axis, a longitudinal coordinate z is depicted. The longitudinal coordinate z, given in micrometers, is chosen such that a position of a focus of the light beam on the z-axis is denoted by position 0, such that all longitudinal coordinates z on the horizontal axis are given as a distance to the focal point of the light beam. Consequently, since the beam cross-section of the light beam depends on the distance from the focal point, the longitudinal coordinate in FIG. 5E denotes the beam cross-section in arbitrary units. As an example, a Gaussian light beam may be assumed, with known or determinable beam parameters, in order to transform the longitudinal coordinate into a specific beam waist or beam cross-section.

In this experiment, longitudinal sensor signals are provided for a variety of modulation frequencies of the light beam, for 0 Hz (no modulation), 7 Hz, 377 Hz and 777 Hz. As can be seen in the figure, for modulation frequency 0 Hz, no FiP effect or only a very small FiP effect, which may not easily be distinguished from the noise of the longitudinal sensor signal, may be detected. For higher modulation frequencies, a pronounced dependency of the longitudinal sensor signal on the cross section of the light beam may be observed. Typically, modulation frequencies in the range of 0.1 Hz to 10 kHz may be used for the detector according to the present invention, such as modulation frequencies of 0.3 Hz.

Further exemplary embodiments of sDSCs may be found in WO 2014/097181 A1.

### LIST OF REFERENCE NUMBERS

110 detector
112 object
114 finger
116 proximity sensor
118 human-machine interface
119 entertainment device
120 optical sensor
122 image plane
124 coordinate system
126 sensor region
128 incident (scattered) light beam
130 signal leads
132 evaluation device
134 illumination source
136 primary light beam
138 illumination lead
140 modulation device
142 display
144 display lead
146 control device
147 evaluation lead
148 transversal evaluation unit
150 longitudinal evaluation unit
152 position information
154 electrode
156 side of the optical sensor
158 substrate
160 first electrode
162 blocking layer
164 n-semiconducting metal oxide
166 dye
168 p-semiconducting organic material
170 second electrode
172 encapsulation
174 electrode contact
176 partial electrode
178 partial electrode, x
180 partial electrode, y
182 contact leads
184 light spot
186 image
188 electrically conductive polymer
190 top contact
192 focal point

1. A detector for determining a position of at least one object with regard to at least one optical sensor having an image plane, the detector comprising:
at least one illumination source, wherein the illumination source emits at least one light beam, wherein the light beam comprises a component which is parallel to the image plane of the optical sensor;
the optical sensor wherein the optical sensor has a sensor region in the image plane, wherein the optical sensor is designed to determine a transversal component of the position of the object in an event where the object approaches the optical sensor in a manner that light is scattered from the component of the light beam conducted parallel to the image plane of the optical sensor, the transversal component of the position being a position in the image plane of the optical sensor being designed to generate at least one transversal sensor signal from the light scattered from the component of the light beam conducted parallel to the image plane of the optical sensor in the sensor region, wherein the optical sensor is further designed to generate at least one longitudinal sensor signal in a manner dependent on an illumination of the sensor region by light which is scattered from the component of the light beam conducted parallel to the image plane of the optical sensor, wherein the longitudinal sensor signal is dependent on a variation of an intensity of the light which is scattered from the component of the light beam conducted parallel to the image plane of the optical sensor in the sensor region; and
an evaluation device, wherein the evaluation device is designed to generate at least one item of information on a transversal component of a position of the object by evaluating the transversal sensor signal and wherein the evaluation device is further designed to generate at least one item of information on a longitudinal component of the position of the object by evaluating the longitudinal sensor signal.

2. The detector according to claim 1, wherein the optical sensor is a photo detector having at least one first electrode, at least one second electrode and at least one photovoltaic material, wherein the photovoltaic material is embedded in between the first electrode and the second electrode, wherein the photovoltaic material is designed to generate electric charges in response to an illumination of the photovoltaic material with light, wherein the second electrode is a split electrode having at least two partial electrodes.

3. The detector according to claim 2, wherein the second electrode is a split electrode having three, four, or more partial electrodes.

4. The detector according to claim 3, wherein electrical currents through the partial electrodes are dependent on a position in the image plane where the light is scattered from the component of the light beam conducted parallel to the image plane of the optical sensor, wherein the optical sensor is designed to generate the transversal sensor signal in accordance with the electrical currents through the partial electrodes.

5. The detector according to claim 2, wherein the detector is designed to derive information on the transversal component of a position of the object from at least one ratio of the currents through the partial electrodes.

6. The detector according to claim 2, wherein the photo detector is a dye-sensitized solar cell.

7. The detector according to claim 2, wherein the first electrode at least partially is made of at least one transparent conductive oxide, wherein the second electrode at least partially is made of an electrically conductive polymer.

8. The detector according to claim 1, wherein the illumination source is located on a side of the optical sensor.

9. The detector according to claim 1, wherein the illumination source is connected with the optical sensor.

10. The detector according to claim 1, wherein the detector comprises at least two separate illumination sources.

11. The detector according to claim 10, wherein the at least two illumination sources form a frame which fully or partially encloses the image plane and/or the optical sensor.

12. The detector according to claim 1, further comprising at least one modulation device for modulating the illumination of the at least one light beam emitted by the illumination source.

13. The detector according to claim 12, wherein at least two separate illumination sources are present, wherein the separate illumination sources differ by a frequency used for modulating the illumination of each illumination source.

14. The detector according to claim 12, wherein the evaluation device is designated to generate the at least one item of information on the longitudinal component of the position of the object from the variation of an the intensity of the light scattered from the component of the light beam conducted parallel to the image plane of the optical sensor in the sensor region.

15. The detector according to claim 14, wherein the evaluation device is designated to generate the at least one item of information on the longitudinal component of the position of the object by determining the variation of a diameter where the light is scattered from the component of the light beam conducted parallel to the image plane of the optical sensor from the at least one longitudinal sensor signal.

16. The detector according to claim 15, wherein the optical sensor is furthermore designated in a manner that the longitudinal sensor signal, given the same total power of the illumination, is dependent on a modulation frequency of a modulation of the illumination at least one modulation device.

17. The detector according to claim 1, wherein the evaluation device is further designated to combine at least two different items of information on a position of the object into a specific command.

18. The detector according to claim 17, wherein the specific command is interpreted as a gesture.

19. The detector according to claim 18, wherein the gesture comprises a function selected from the group consisting of a click, a double click, a rotation, a zoom function, and a drag-and-drop movement.

20. A human-machine interface for exchanging at least one item of information between a user and a machine, the human-machine interface comprising at least one detector according to claim 1,
wherein the human-machine interface is designated to generate at least one item of geometrical information of the object related to the user via the detector.

21. The human-machine interface according to claim 20, wherein the object is a part of the user or an article designed for a movement by the user.

22. The human-machine interface according to claim 20, further comprising at least one display,
wherein the optical sensor is transparent and/or translucent and is located with respect to the display in a manner that the display is fully or partially visible through the optical sensor.

23. The human-machine interface according to claim 22, wherein the display is a dynamic display.

24. An entertainment device for carrying out at least one entertainment function, the entertainment device comprising at least one human-machine interface according to claim 20,
wherein the entertainment device is designed to enable at least one item of information to be input by a player via the human-machine interface, and wherein the entertainment device is designed to vary the entertainment function in accordance with the information.

25. A method for determining a component of a position of at least one object with regard to at least one optical sensor having an image plane, the method comprising
emitting at least one light beam from at least one illumination source, wherein the light beam comprises a component which is parallel to the image plane of the optical sensor;
determining, by using the at least one optical sensor having a sensor region in the image plane, a transversal component of the position of the object in an event where the object approaches the optical sensor in a manner that light is scattered from the component of the light beam conducted parallel to the image plane of the optical sensor, the transversal component of the position being a position in the image plane, the optical sensor generating at least one transversal sensor signal from the light scattered from the component of the light beam conducted parallel to the image plane in the sensor region and at least one longitudinal sensor signal in a manner dependent on an illumination of the sensor region by light which is scattered from the component of the light beam conducted parallel to the image plane, wherein the longitudinal sensor signal is dependent on a variation of an intensity of the light which is scattered from the component of the light beam conducted parallel to the image plane of the optical sensor in the sensor region; and
generating from at least one evaluation device at least one item of information on a transversal component of a position of the object by evaluating the transversal sensor signal and at least one item of information on a longitudinal component of a position of the object by evaluating the longitudinal sensor signal.

26. A method for making a human-machine interface and/or an entertainment device, the method comprising incorporating the detector according to claim 1 into the human-machine interface and/or the entertainment device as a proximity sensor.
